(19) United States
(12) Patent Application Publication
(10) Pub. No.: US 2001/0018731 A1
(43) Pub. Date: Aug. 30, 2001

(54) Memory management device and memory management method thereof

(75) Inventors: Masahiro Fujii, Tokyo (JP); Kazuya Inoue, Kanagawa (JP)

Correspondence Address: YOUNG & THOMPSON, 745 SOUTH 23RD STREET 2ND FLOOR, ARLINGTON, VA, 22202

(73) Assignee: NEC CORPORATION

(21) Appl. No.: 09/790,571

(22) Filed: Feb. 23, 2001

(30) Foreign Application Priority Data
Feb. 24, 2000 (JP) 2000-046885

(51) Int. Cl. G06F 12/00

(52) U.S. Cl. 711/170; 711/202

(57) ABSTRACT

A local memory is composed of a memory region to and from which write and read is conducted and a management data region for managing the memory region. The memory region is composed of a plurality of layers of memory cells such as a first memory cell as a fixed smallest-size memory cell, a second memory cell whose size is N (e.g. 8) times the size of the first memory cell and a third memory cell whose size is further N times the size of the second memory cell, each memory cell being managed by a corresponding bit map unit. Upon a request for obtaining memory, a memory cell whose size is equal to or larger than and most approximate to the requested size is selected and a free region of the selected memory cell is checked by the corresponding bit map unit to obtain the region. Even a request for memory of various sizes, therefore, can be efficiently coped with and segregative use of obtained memory regions enables fragmentation to be less liable to occur.

### BACKGROUND OF THE INVENTION

1. Field of the Invention

The present invention relates to a memory management device for managing memory regions and a memory management method thereof and, more particularly, to a memory management device for managing allocation and release of memory regions and a memory management method thereof.

2. Description of the Related Art

Various kinds of memories or storage devices such as a hard disc, an optical disc and a semiconductor memory are used for storing data. For storing data in such a memory, memory region allocation processing is conducted, while for data which becomes unnecessary or is to be moved elsewhere, memory region releasing processing is conducted. Such processing, in an ordinary case, is executed using an operation system of a microprocessor.

FIGS. 45 and 46 show the technique disclosed in Japanese Patent Laying-Open (Kokai) No. Heisei 8-221317 as a conventional memory region management method. In a local memory 101 (FIG. 45) whose read and write are controlled by a CPU (Central Processing Unit) not shown, a memory region 102 in which data is to be stored and a management data region 103 for managing the memory region 102 are arranged. The memory region 102 is composed of numerous memory cells 104 as memory blocks of a fixed length.

The management data region 103 is composed of an address unit 105, a real data size unit 106, a cell size unit 107, a bit map unit 108 and a variable-length tag unit 109. The address unit 105 here is a place where, when each data is stored by successively occupying an arbitrary number of memory cells 104, address information indicative of a storage position of each data is stored. The real data size unit 106 represents a memory size of each data composed of an arbitrary number of memory cells 104.

The cell size unit 107 represents a size (capacity) of the memory cell 104 itself. The bit map unit 108 represents whether each memory cell 104 constituting the memory region 102 stores data or not as bit map data in matrix. For example, when a certain memory cell 104 is not in use, a bit corresponding to the bit map unit 108 indicates “0” and when it is in use, the bit indicates “1”.

The variable-length tag unit 109 is for managing a variable-length memory block. For one variable-length block, the variable-length tag unit 109 has, as data, a cell start 111 as position information and the number 112 of successive cells as one memory block.

More specifically, it is a conventional practice to divide a memory region on a local memory into memory cells 104 as fixed-length memory blocks and manage a state of in use and a state of not in use of each of these divisional memory cells as bit map data. Then, with respect to a large volume of data which can not be handled by one memory cell 104, considering these data as a rare case of memory block management, memory management using variable-length memory blocks is conducted.

FIG. 46 is a diagram for use in explaining a manner of managing variable-length memory blocks. FIG. 46(a) shows one example of the variable-length tag unit 109 in management data. When a request for ensuring memory is made, a place will be searched for where the memory cells 104 exist in succession equivalent to a size enough for the requested memory. In FIG. 46, the cell start 111 and the number of cells 112 both indicate “3”. When such a request is made, check the bit map unit 108 shown in FIG. 45, for example, from the beginning to find a place where not less than “3” of cells not in use exist in succession.

Then, rewrite three of the cells not in use from bit “0” to “1” to bring them to a state of in use. In the example shown in FIG. 46(b), for example, such rewriting is conducted in the bit map unit 108 starting at a place indicated by an arrow 121. Thus, allocation of a memory region is conducted by giving an address so as to be used by a user for the corresponding memory cell 104 as shown in FIG. 46(c). When allocation is thus executed, register the start 111 of the relevant memory cell 104 and the number 112 of the allocated cells 104 at variable-length tags of the variable-length tag unit 109.

Next, description will be made of a case of releasing a part of the memory region of the local memory 101 shown in FIG. 45. When releasing an ensured memory block, the above-described CPU checks a variable-length tag of the variable-length tag unit 109. Then, obtain a starting position of the memory cell 104 indicated by the cell start 111 in the variable-length tag coinciding with the above-described address information. Then, rewrite as many bits “1” of the bit map unit 108 as the number registered as the number 112 of cells in the variable-length tag to bits “0”. As a result, the rewritten part enters a state of not in use to release the relevant region of the memory region 102.

The conventional memory region management method shown in FIGS. 45 and 46 has the following problems.

First, the method is first of all premised on that a volume of data handled by memory is substantially fixed. In other words, the method is premised on memory management in a memory system whose volume of data is fixed in advance. Then, in an ordinary case, memory management is conducted on a memory cell 104 basis. Therefore, in a case where each data handled by an application varies within a wide range, unless the capacity of each memory cell 104 is set to be large enough, introduction of the system will need frequent use of the variable-length tag unit 109, resulting in inviting an increase in the management data region 103.

On the other hand, when the capacity of each memory cell 104 is set to be large enough at the cell size unit 107, even data of a small size will be stored in the memory cell 104 of a large size. This accordingly causes drastic reduction in a memory use efficiency.

Secondly, in the conventional system shown in FIG. 45, data having a relatively large size whose appearance is not so frequent is handled by the use of the variable-length tag unit 109. In this latter case, for ensuring memory, the bit map unit 108 is checked by a predetermined procedure according to the size of data to be ensured. As a result, a time required for searching will be increased in proportional to a size of the memory region 102. Also in releasing memory, it will cost more search time as the memory region 102 is increased.

Thirdly, conducting memory management by the latter manner for a long time enhances division of a part where the memory cells 104 not in use exist in succession. More specifically, a part having a possibility of being a relatively large-size memory region because of successive existence of many memory cells 104 will be divided because sequential ensuring of memory is conducted at random. Accordingly, even ensuring memory is requested, it will gradually become more difficult to allocate a region equivalent to the requested size.

### SUMMARY OF THE INVENTION

An object of the present invention is to provide a memory management device enabling memory to be ensured and released at a high speed irrespective of a size of a requested memory region and a memory management method thereof.

Another object of the present invention is to provide a memory management device which hardly causes a fragment in a memory region and a memory management method thereof.

According to the first aspect of the invention, a memory management device comprises

memory region size storing means for storing a size of a predetermined-size readable and writable memory region,

first memory size storing means for storing a size of a fixed-length block as a first memory cell which divides a memory region of a size stored in the memory region size storing means,

a first bit map unit for storing a state of use of each the first memory cell in the memory region as a bit map,

second to a-th bit map units for, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map,

memory cell layer selecting means for, upon a request for ensuring memory in the memory region, selecting a layer of a memory cell whose size is smaller than and most approximate to the requested memory size,

address searching means for searching a bit map unit corresponding to a memory cell of a layer selected by the memory cell layer selecting means for an address indicative of a place at which the minimum number of successive memory cells exist necessary for satisfying the size of the memory requested to be ensured, and

memory ensuring means for ensuring the memory region equivalent to the minimum number of successive memory cells necessary for satisfying the size of the memory requested to be ensured by using an address searched by the address searching means.

According to a first invention, since a hierarchical structure is used for a memory cell, it is possible in response to a request for memory of various sizes to switch and search a bit map unit for ensuring a necessary region. Accordingly, irrespective of a size of a memory region requested, processing of ensuring and releasing memory can be conducted at a high speed. In addition, because a plurality of sizes are set for memory cells, segregative use of regions ensured according to these sizes is possible, so that division of successive memory not in use in the memory region is less liable to occur.

In the preferred construction, the address searching means has a search direction set to have address search directions be opposite to each other in layers in which memory sizes are adjacent.

In another preferred construction, the memory management device further comprises release-time memory cell selecting means for, upon a request for releasing memory ensured in the memory region, selecting a memory cell whose size is smaller than and most approximate to a size of the memory to be released, release-time searching means for searching a bit map indicative of a state of a memory cell selected by the release-time memory cell selecting means for a memory cell to be released, and memory releasing means for releasing a relevant data region of a memory cell searched by the release-time searching means.

According to the second aspect of the invention, a memory management device comprises

memory region size storing means for storing a size of a predetermined-size readable and writable memory region,

first memory size storing means for storing a size of a fixed-length block as a first memory cell which divides a memory region of a size stored in the memory region size storing means,

a first bit map unit for storing a state of use of each the first memory cell in the memory region as a bit map indicative any of at least three states of “not in use” indicating a state where a memory cell is not in use, “partly in use” indicating a state where a memory cell is partly in use and “in use” indicating a state where all the memory cell is in use,

second to a-th bit map units for, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map indicative any of at least three states of “not in use” indicating a state where a memory cell is not in use, “partly in use” indicating a state where a memory cell is partly in use and “in use” indicating a state where all the memory cell is in use,

memory cell layer selecting means for, upon a request for ensuring memory in the memory region, selecting a layer of a memory cell whose size is smaller than and most approximate to the requested memory size,

address searching means for searching a bit map unit corresponding to a memory cell of a layer selected by the memory cell layer selecting means for an address indicative of a place at which one or a plurality of successive memory cells exist where data equivalent to the size of the memory requested to be ensured can be successively stored, with a memory cell at the state of “not in use” or “partly in use” as a leading address,

memory ensuring means for ensuring the memory region equivalent to the minimum number of successive memory cells necessary for satisfying the size of the memory requested to be ensured by using an address searched by the address searching means, and

bit map unit changing means for changing states of a bit map corresponding to a memory cell ensured by the memory ensuring means and a bit map corresponding to a memory cell whose layer is higher than the layer of the ensured memory cell and whose state is subjected to a change into “partly in use” or “in use” according to the state obtained after the change.

In the preferred construction, the address searching means has a search direction set to have address search directions be opposite to each other in layers in which memory sizes are adjacent.

In another preferred construction, the memory management device further comprises adjacent memory cell determining means for, when successive free regions exist at a place where two memory cells are adjacent to each other at least one of which is at the state of “partly in use”, determining whether the successive free regions are larger than the size of the requested memory at the time when the request for ensuring the memory is made.

In another preferred construction, the memory management device further comprises release-time memory cell selecting means for, upon a request for releasing memory ensured in the memory region, selecting a memory cell whose size is smaller than and most approximate to a size of the memory to be released, release-time searching means for searching a bit map indicative of a state of a memory cell selected by the release-time memory cell selecting means for a memory cell to be released, and memory releasing means for releasing a relevant data region of a memory cell searched by the release-time searching means.

According to the third aspect of the invention, a memory management device comprises

memory region size storing means for storing a size of a predetermined-size readable and writable memory region,

first memory size storing means for storing a size of a fixed-length block as a first memory cell which divides a memory region of a size stored in the memory region size storing means,

a first bit map unit for storing a state of use of each the first memory cell in the memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

second to a-th bit map units for, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

memory cell layer selecting means for, upon a request for ensuring memory in the memory region, selecting a layer of a memory cell whose size is smaller than and most approximate to the requested memory size,

address searching means for searching a bit map unit corresponding to a memory cell of a layer selected by the memory cell layer selecting means for an address indicative of a place at which one or a plurality of successive memory cells exist where data equivalent to the size of the memory requested to be ensured can be successively stored, with a memory cell at the state of “not in use” or “partly in use” as a leading address,

memory ensuring means for ensuring the memory region equivalent to the minimum number of successive memory cells necessary for satisfying the size of the memory requested to be ensured by using an address searched by the address searching means, and

bit map unit changing means for changing a bit map corresponding to a memory cell ensured by the memory ensuring means into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

In the preferred construction, the address searching means has a search direction set to have address search directions be opposite to each other in layers in which memory sizes are adjacent.

In another preferred construction, the memory management device further comprises adjacent memory cell determining means for, when successive free regions exist at a place where two memory cells are adjacent to each other at least one of which is at the state of “partly in use”, determining whether the successive free regions are larger than the size of the requested memory at the time when the request for ensuring the memory is made.

In another preferred construction, the memory management device further comprises release-time memory cell selecting means for, upon a request for releasing memory ensured in the memory region, selecting a memory cell whose size is smaller than and most approximate to a size of the memory to be released, release-time searching means for searching a bit map indicative of a state of a memory cell selected by the release-time memory cell selecting means for a memory cell to be released, and memory releasing means for releasing a relevant data region of a memory cell searched by the release-time searching means.

In another preferred construction, a leading address of memory to be released is searched for from among memory cells at the state of “head of allocation”.

According to another aspect of the invention, a memory management device comprises

memory region size storing means for storing a size of a predetermined-size readable and writable memory region,

first memory size storing means for storing a size of a fixed-length block as a first memory cell which divides a memory region of a size stored in the memory region size storing means,

a first bit map unit for storing a state of use of each the first memory cell in the memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

second to a-th bit map units for, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

one-order higher layer memory cell selecting means for, upon a request for ensuring memory in the memory region, determining whether there exists a memory cell whose size is relatively close to and larger than the requested memory size,

first memory cell layer selecting means for, when the one-order higher layer memory cell selecting mean determines that there exists no memory cell satisfying the condition, selecting a layer of a memory cell whose size is smaller and most approximate to the requested memory size,

second memory cell layer selecting means for, when the one-order higher layer memory cell selecting mean determines that there exists a memory cell satisfying the condition, selecting the memory cell of the layer,

address searching means for searching a bit map unit corresponding to a memory cell of a layer selected by the first or second memory cell layer selecting means for an address indicative of a place at which one or a plurality of successive memory cells exist where data equivalent to the size of the memory requested to be ensured can be successively stored, with a memory cell at the state of “not in use” or “partly in use” as a leading address,

memory ensuring means for ensuring the memory region equivalent to the minimum number of successive memory cells necessary for satisfying the size of the memory requested to be ensured by using an address searched by the address searching means, and

bit map unit changing means for changing a bit map corresponding to a memory cell ensured by the memory ensuring means into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

In the preferred construction, the address searching means has a search direction set to have address search directions be opposite to each other in layers in which memory sizes are adjacent.

In another preferred construction, the memory management device further comprises adjacent memory cell determining means for, when successive free regions exist at a place where two memory cells are adjacent to each other at least one of which is at the state of “partly in use”, determining whether the successive free regions are larger than the size of the requested memory at the time when the request for ensuring the memory is made.

In another preferred construction, the memory management device further comprises release-time memory cell selecting means for, upon a request for releasing memory ensured in the memory region, selecting a memory cell whose size is smaller than and most approximate to a size of the memory to be released, release-time searching means for searching a bit map indicative of a state of a memory cell selected by the release-time memory cell selecting means for a memory cell to be released, and memory releasing means for releasing a relevant data region of a memory cell searched by the release-time searching means.

In another preferred construction, a leading address of memory to be released is searched for from among memory cells at the state of “head of allocation”.

According to another aspect of the invention, a memory management device comprises

memory region size storing means for storing a size of a predetermined-size readable and writable memory region,

first memory size storing means for storing a size of a fixed-length block as a first memory cell which divides a memory region of a size stored in the memory region size storing means,

a first bit map unit for storing a state of use of each the first memory cell in the memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

second to a-th bit map units for, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

memory cell selecting means for, upon a request for ensuring memory in the memory region, selecting a combination of memory cells satisfying the requested memory size by combining a memory cell whose size is smaller than and most approximate to the requested memory size and a memory cell of a further smaller size,

address searching means for searching a bit map unit corresponding to a memory cell of each layer selected by the memory cell selecting means for an address indicative of a place at which one or a plurality of successive memory cells exist where data equivalent to the size of the memory requested to be ensured can be successively stored, with a memory cell at the state of “not in use” or “partly in use” as a leading address,

memory ensuring means for ensuring the memory region equivalent to the minimum number of successive memory cells necessary for satisfying the size of the memory requested to be ensured by using an address searched by the address searching means, and

bit map unit changing means for changing a bit map corresponding to a memory cell ensured by the memory ensuring means into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

According to another aspect of the invention, a memory management device comprises

memory region size storing means for storing a size of a predetermined-size readable and writable memory region,

first memory size storing means for storing a size of a fixed-length block as a first memory cell which divides a first memory region obtained by dividing a memory region of a size stored in the memory region size storing means in half at a predetermined address as a boundary,

a first bit map unit for storing a state of use of each the first memory cell in the first memory region as a bit map indicative any of four states of “not in use” indicating a state where a memory cell is not in use, “partly in use” indicating a state where a memory cell is partly in use, “in use” indicating a state where all the memory cells is in use, and “head of allocation” indicating the head of a memory cell where data of a requested memory size is stored,

second to a-th bit map units for, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, allocating these memory cells to the first memory region and a remaining second memory region and storing a state of use of each memory cell corresponding to the first and the second memory regions as a bit map,

memory cell layer selecting means for, upon a request for ensuring memory in the memory region, selecting a layer of a memory cell whose size is smaller than and most approximate to the requested memory size,

address searching means for searching a bit map unit corresponding to a memory cell of a layer selected by the memory cell layer selecting means for an address indicative of a place at which the minimum number of successive memory cells exist necessary for satisfying the size of the memory requested to be ensured, and

memory ensuring means for ensuring the memory region equivalent to the minimum number of successive memory cells necessary for satisfying the size of the memory requested to be ensured by using an address searched by the address searching means.

According to another aspect of the invention, a memory management device comprises

memory region size storing means for storing a size of a predetermined-size readable and writable memory region,

first memory size storing means for storing a size of a fixed-length block as a first memory cell which divides a first memory region obtained by dividing a memory region of a size stored in the memory region size storing means in half at a predetermined address as a boundary,

a first bit map unit for storing a state of use of each the first memory cell in the first memory region as a bit map,

second to a-th bit map units for, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, representing a state of use of each memory cell as any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored, allocating these memory cells to the first memory region and a remaining second memory region and storing a state of use of each memory cell corresponding to the first and the second memory regions as a bit map,

memory cell selecting means for, upon a request for ensuring memory in the memory region, selecting a combination of memory cells satisfying the requested memory size by combining a memory cell whose size is smaller than and most approximate to the requested memory size and a memory cell of a further smaller size,

address searching means for searching a bit map unit corresponding to a memory cell of each layer selected by the memory cell selecting means for an address indicative of a place at which one or a plurality of successive memory cells exist where data equivalent to the size of the memory requested to be ensured can be successively stored, with a memory cell at the state of “not in use” or “partly in use” as a leading address,

memory ensuring means for ensuring the memory region equivalent to the minimum number of successive memory cells necessary for satisfying the size of the memory requested to be ensured by using an address searched by the address searching means, and

bit map unit changing means for changing a bit map corresponding to a memory cell ensured by the memory ensuring means into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

In the preferred construction, the memory management device further comprises release-time memory cell selecting means for, upon a request for releasing memory ensured in the memory region, selecting a memory cell whose size is smaller than and most approximate to a size of the memory to be released, release-time searching means for searching a bit map indicative of a state of a memory cell selected by the release-time memory cell selecting means for a memory cell to be released, and memory releasing means for releasing a relevant data region of a memory cell searched by the release-time searching means.

In another preferred construction, the memory management device further comprises release-time bit map changing means for, when the memory releasing means releases memory from the memory region, changing a memory cell selected by the release-time memory cell selecting means into the state of “not in use” or “partly in use” depending on the state of the memory cell, and changing, to the state of “not in use”, a bit map corresponding to the selected memory cell and among higher-order bit maps covering the bit map, a bit map in which no other relevant memory cell is in use and changing a bit map in which relevant memory cells are changed to the state of partly in use into the state of “partly in use”.

According to a further aspect of the invention, a memory management method comprises

a memory region size storing step of storing a size of a predetermined-size readable and writable memory region,

a first memory size storing step of storing a size of a fixed-length block as a first memory cell which divides a memory region of a size stored at the memory region size storing step,

a first bit map unit storing step of storing a state of use of each the first memory cell in the memory region as a bit map,

a second to a-th bit map unit storing step of, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map,

a memory cell layer selecting step of, upon a request for ensuring memory in the memory region, selecting a layer of a memory cell whose size is smaller than and most approximate to the requested memory size,

an address searching step of searching a bit map unit corresponding to a memory cell of a layer selected by the memory cell layer selecting step for an address indicative of a place at which the minimum number of successive memory cells exist necessary for satisfying the size of the memory requested to be ensured, and

a memory ensuring step of ensuring the memory region equivalent to the minimum number of successive memory cells necessary for satisfying the size of the memory requested to be ensured by using an address searched by the address searching step.

According to a further aspect of the invention, a memory management method comprises

a memory region size storing step for storing a size of a predetermined-size readable and writable memory region,

a first memory size storing step of storing a size of a fixed-length block as a first memory cell which divides a memory region of a size stored at the memory region size storing step,

a first bit map unit storing step of storing a state of use of each the first memory cell in the memory region as a bit map indicative any of at least three states of “not in use” indicating a state where a memory cell is not in use, “partly in use” indicating a state where a memory cell is partly in use and “in use” indicating a state where all the memory cell is in use,

a second to a-th bit map unit storing step of, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map indicative any of at least three states of “not in use” indicating a state where a memory cell is not in use, “partly in use” indicating a state where a memory cell is partly in use and “in use” indicating a state where all the memory cell is in use,

a memory cell layer selecting step of, upon a request for ensuring memory in the memory region, selecting a layer of a memory cell whose size is smaller than and most approximate to the requested memory size,

an address searching step of searching a bit map unit corresponding to a memory cell of a layer selected by the memory cell layer selecting step for an address indicative of a place at which one or a plurality of successive memory cells exist where data equivalent to the size of the memory requested to be ensured can be successively stored, with a memory cell at the state of “not in use” or “partly in use” as a leading address,

a memory ensuring step of ensuring the memory region equivalent to the minimum number of successive memory cells necessary for satisfying the size of the memory requested to be ensured by using an address searched by the address searching step, and

a bit map unit changing step of changing states of a bit map corresponding to a memory cell ensured by the memory ensuring step and a bit map corresponding to a memory cell whose layer is higher than the layer of the ensured memory cell and whose state is subjected to a change into “partly in use” or “in use” according to the state obtained after the change.

According to a further aspect of the invention, a memory management method comprises

a memory region size storing step of storing a size of a predetermined-size readable and writable memory region,

a first memory size storing step of storing a size of a fixed-length block as a first memory cell which divides a memory region of a size stored in the memory region size storing step,

a first bit map unit storing step of storing a state of use of each the first memory cell in the memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

a second to a-th bit map unit storing step of, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

a memory cell layer selecting step of, upon a request for ensuring memory in the memory region, selecting a layer of a memory cell whose size is smaller than and most approximate to the requested memory size,

an address searching step of searching a bit map unit corresponding to a memory cell of a layer selected by the memory cell layer selecting step for an address indicative of a place at which one or a plurality of successive memory cells exist where data equivalent to the size of the memory requested to be ensured can be successively stored, with a memory cell at the state of “not in use” or “partly in use” as a leading address,

a memory ensuring step of ensuring the memory region equivalent to the minimum number of successive memory cells necessary for satisfying the size of the memory requested to be ensured by using an address searched by the address searching step, and

a bit map unit changing step of changing a bit map corresponding to a memory cell ensured by the memory ensuring step into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

According to a further aspect of the invention, a memory management method comprising:

a memory region size storing step of storing a size of a predetermined-size readable and writable memory region,

a first memory size storing step of storing a size of a fixed-length block as a first memory cell which divides a memory region of a size stored at the memory region size storing step,

a first bit map unit storing step of storing a state of use of each the first memory cell in the memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

a second to a-th bit map unit storing step of, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

a one-order higher layer memory cell selecting step of, upon a request for ensuring memory in the memory region, determining whether there exists a memory cell whose size is relatively close to and larger than the requested memory size,

a first memory cell layer selecting step of, when the one-order higher layer memory cell selecting step determines that there exists no memory cell satisfying the condition, selecting a layer of a memory cell whose size is smaller and most approximate to the requested memory size,

a second memory cell layer selecting step of, when the one-order higher layer memory cell selecting step determines that there exists a memory cell satisfying the condition, selecting the memory cell of the layer,

an address searching step of searching a bit map unit corresponding to a memory cell of a layer selected by the first or second memory cell layer selecting step for an address indicative of a place at which one or a plurality of successive memory cells exist where data equivalent to the size of the memory requested to be ensured can be successively stored, with a memory cell at the state of “not in use” or “partly in use” as a leading address,

a memory ensuring step of ensuring the memory region equivalent to the minimum number of successive memory cells necessary for satisfying the size of the memory requested to be ensured by using an address searched by the address searching step, and

a bit map unit changing step of changing a bit map corresponding to a memory cell ensured by the memory ensuring step into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

According to a further aspect of the invention, a memory management method comprising:

a memory region size storing step of storing a size of a predetermined-size readable and writable memory region,

a first memory size storing step of storing a size of a fixed-length block as a first memory cell which divides a memory region of a size stored at the memory region size storing step,

a first bit map unit storing step of storing a state of use of each the first memory cell in the memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

a second to a-th bit map unit storing step of storing, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

a memory cell selecting step of, upon a request for ensuring memory in the memory region, selecting a combination of memory cells satisfying the requested memory size by combining a memory cell whose size is smaller than and most approximate to the requested memory size and a memory cell of a further smaller size,

an address searching step of searching a bit map unit corresponding to a memory cell of each layer selected by the memory cell selecting step for an address indicative of a place at which one or a plurality of successive memory cells exist where data equivalent to the size of the memory requested to be ensured can be successively stored, with a memory cell at the state of “not in use” or “partly in use” as a leading address,

a memory ensuring step of ensuring the memory region equivalent to the minimum number of successive memory cells necessary for satisfying the size of the memory requested to be ensured by using an address searched at the address searching step, and a bit map unit changing step of changing a bit map corresponding to a memory cell ensured by the memory ensuring step into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

According to a further aspect of the invention, a memory management method comprises

a memory region size storing step of storing a size of a predetermined-size readable and writable memory region,

a first memory size storing step of storing a size of a fixed-length block as a first memory cell which divides a first memory region obtained by dividing a memory region of a size stored at the memory region size storing step in half at a predetermined address as a boundary,

a first bit map unit storing step of storing a state of use of each the first memory cell in the first memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,

a second to a-th bit map unit storing step of, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, allocating these memory cells to the first memory region and a remaining second memory region and storing a state of use of each memory cell corresponding to the first and the second memory regions as a bit map,

a memory cell layer selecting step of, upon a request for ensuring memory in the memory region, selecting a layer of a memory cell whose size is smaller than and most approximate to the requested memory size,

an address searching step of searching a bit map unit corresponding to a memory cell of a layer selected by the memory cell layer selecting step for an address indicative of a place at which the minimum number of successive memory cells exist necessary for satisfying the size of the memory requested to be ensured, and

a memory ensuring step of ensuring the memory region equivalent to the minimum number of successive memory cells necessary for satisfying the size of the memory requested to be ensured by using an address searched by the address searching step.

According to a further aspect of the invention, a memory management method comprises

a memory region size storing step of storing a size of a predetermined-size readable and writable memory region,

a first memory size storing step of storing a size of a fixed-length block as a first memory cell which divides a first memory region obtained by dividing a memory region of a size stored at the memory region size storing step in half at a predetermined address as a boundary,

a first bit map unit storing step of storing a state of use of each the first memory cell in the first memory region as a bit map,

a second to a-th bit map unit storing step of, when each N times, which is a predetermined integral multiple, the memory amount of the first memory cell is grouped into a higher-order memory cell and each N times the memory amount of the higher-order memory cell is further grouped into a further higher-order memory cell to layer the memory region to have (a−1) layers (a: integer not less than 2) as the maximum layer and set these memory cells as the second to a-th memory cells, representing a state of use of each memory cell as any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored, allocating these memory cells to the first memory region and a remaining second memory region and storing a state of use of each memory cell corresponding to the first and the second memory regions as a bit map,

a memory cell selecting step of, upon a request for ensuring memory in the memory region, selecting a combination of memory cells satisfying the requested memory size by combining a memory cell whose size is smaller than and most approximate to the requested memory size and a memory cell of a further smaller size,

an address searching step of searching a bit map unit corresponding to a memory cell of each layer selected by the memory cell selecting step for an address indicative of a place at which one or a plurality of successive memory cells exist where data equivalent to the size of the memory requested to be ensured can be successively stored, with a memory cell at the state of “not in use” or “partly in use” as a leading address,

a memory ensuring step of ensuring the memory region equivalent to the minimum number of successive memory cells necessary for satisfying the size of the memory requested to be ensured by using an address searched at the address searching step, and

a bit map unit changing step of changing a bit map corresponding to a memory cell ensured at the memory ensuring step into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is an explanatory diagram illustrating a structure o f a me mory cell of the present invention;

FIG. 2 is an explanatory diagram illustrating the first half of one example of sizes required of memory in a system to which a memory management device is applied and the number of times a memory region is allocated at the respective required sizes;

FIG. 3 is an explanatory diagram showing the latter half of one example of sizes required of memory in the system to which the memory management device is applied and the number of times a memory region is allocated at the respective required sizes;

FIG. 4 is an explanatory diagram showing, in a case where a hierarchical structure of a memory has five layers, the frequency of access of each layer with respect to a memory access state of the examples illustrated in FIGS. 2 and 3;

FIG. 5 is an explanatory diagram showing, in a case where a hierarchical structure of memory has four layers, the frequency of access of each layer with respect to a memory access state of the examples illustrated in FIGS. 2 and 3;

FIG. 6 is an explanatory diagram showing a memory region in a case where a hierarchical structure of memory has three layers;

FIG. 7 is a diagram for use in explaining one example of data ensuring by a memory management device having the hierarchical structure as shown in FIG. 6;

FIG. 8 is a diagram for use in explaining a first example which shows a case where ensuring a memory region having a volume of data a little exceeding a largest-size memory cell capacity is requested;

FIG. 9 is a diagram for use in explaining a second example which shows a case where ensuring a memory region having a volume of data a little exceeding a largest-size memory cell capacity is requested;

FIG. 10 is an explanatory diagram showing a state as of after operation (4) and (5) is further conducted at the state shown in FIG. 9;

FIG. 11 is an explanatory diagram showing a state of memory occupied at a time when operation (1) to (3) is finished in a conventional case where the size of a memory cell is one kind;

FIG. 12 is an explanatory diagram showing a state of memory occupied at a time when operation (4) and (5) is finished in a conventional case;

FIG. 13 is an explanatory diagram showing how memory region search directions are alternately set in a memory management device having a hierarchical structure in which a memory cell has an eight-fold increase each in size;

FIG. 14 is an explanatory diagram showing a relationship between a boundary position and a memory cell when elaborating search starting position;

FIG. 15 is an explanatory diagram showing outlines of one of memory cell management methods which can be adopted by the present invention;

FIG. 16 is an explanatory diagram showing another example of memory cell management methods which can be adopted by the present invention;

FIG. 17 is an explanatory diagram showing an example, when the method shown in FIG. 16 is adopted, where large change is caused in a higher-order bit map;

FIG. 18 is an explanatory diagram showing another example of allocation of a memory space in a memory region;

FIG. 19 is a block diagram showing an entire structure of a memory management device according to one embodiment of the present invention;

FIG. 20 is an explanatory diagram showing outlines of a structure of a local memory in the present embodiment;

FIG. 21 is an explanatory diagram showing a structure of a specific management data region in a case where N of the N-th memory cell in the present embodiment is “8”;

FIG. 22 is an explanatory diagram showing specific arrangement of a memory region in a case where N of the N-th memory cell in the present embodiment is “8”;

FIG. 23 is a flow chart showing a flow of processing for obtaining a structure of a management hierarchy from a size of memory which is requested to be ensured in the present embodiment;

FIG. 24 is a flow chart showing a flow of processing for calculating the number of memory cells required in the management hierarchy obtained in FIG. 23;

FIG. 25 is an explanatory diagram showing how processing is conducted after ensuring 2 Mbyte memory is requested in the present embodiment;

FIG. 26 is an explanatory diagram showing the principle of processing of finding whether each memory cell is at a state of not in use or not based on a determination result of a bit map unit;

FIG. 27 is an explanatory diagram showing how a management data region is changed at a time when memory ensuring processing is completed in the present embodiment;

FIG. 28 is a flow chart showing a flow of memory management operation in a case where first processing operation is requested in the present embodiment;

FIG. 29 is a flow chart showing an initial part of a series of processing operation for searching and allocating a third party's memory cell conducted on the side of a CPU;

FIG. 30 is a flow chart showing processing subsequent to Step S654 or S655 in FIG. 29;

FIG. 31 is a flow chart showing processing subsequent to Step S667 of FIG. 30;

FIG. 32 is a flow chart mainly showing a flow of processing conducted when at Step S673 of FIG. 31, determination is made of “not in use” or “partly in use”;

FIG. 33 is a flow chart mainly showing a flow of processing conducted when at Steps S671 and S674 of FIG. 31 that determination of negation (N) is made;

FIG. 34 is an explanatory diagram showing a state of processing conducted when ensuring 30-Mbyte memory is additionally requested in the present embodiment;

FIG. 35 is an explanatory diagram showing the principle of processing of finding whether each memory cell is at the state of not in use or not based on determination results of the bit map unit;

FIG. 36 is an explanatory diagram showing how the management data region is changed when the first processing operation is completed in the present embodiment;

FIG. 37 is an explanatory diagram showing a state of a memory region in which memory is ensured corresponding to FIG. 36;

FIG. 38 is an explanatory diagram showing a position of a memory block whose memory region is requested to be released by a user in the present embodiment;

FIG. 39 is an explanatory diagram showing how existence of a bit string indicative of the head of a block used is checked in the present embodiment;

FIG. 40 is an explanatory diagram showing processing conducted after a first memory cell is set to be not in use in the present embodiment;

FIG. 41 is a flow chart showing a first stage of memory releasing processing conducted when third processing operation is requested in the present embodiment;

FIG. 42 is a flow chart showing succession of the processing shown at Step S732 of FIG. 41;

FIG. 43 is a flow chart showing processing conducted after determination of a state of “head of allocation” is made at Step S739;

FIG. 44 is a flow chart showing a flow of processing conducted when determination of negation (N) is made at Steps S742 and S735 of FIG. 43;

FIG. 45 is an explanatory diagram showing outlines of a structure of a conventionally proposed local memory; and

FIG. 46 is an explanatory diagram showing the progress of processing conducted when ensuring memory is requested in the proposed local memory shown in FIG. 45.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

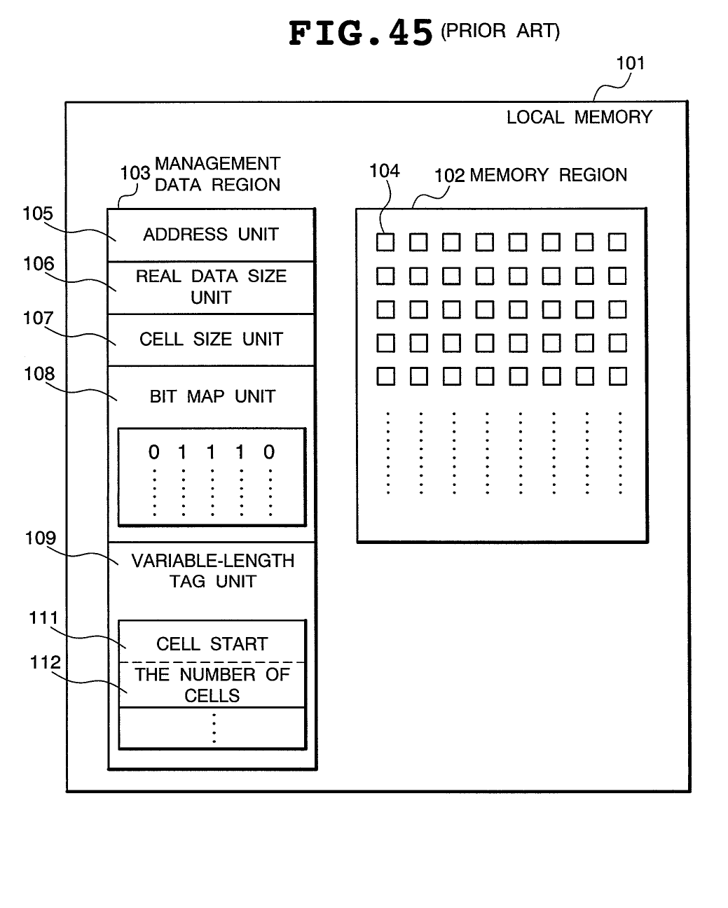

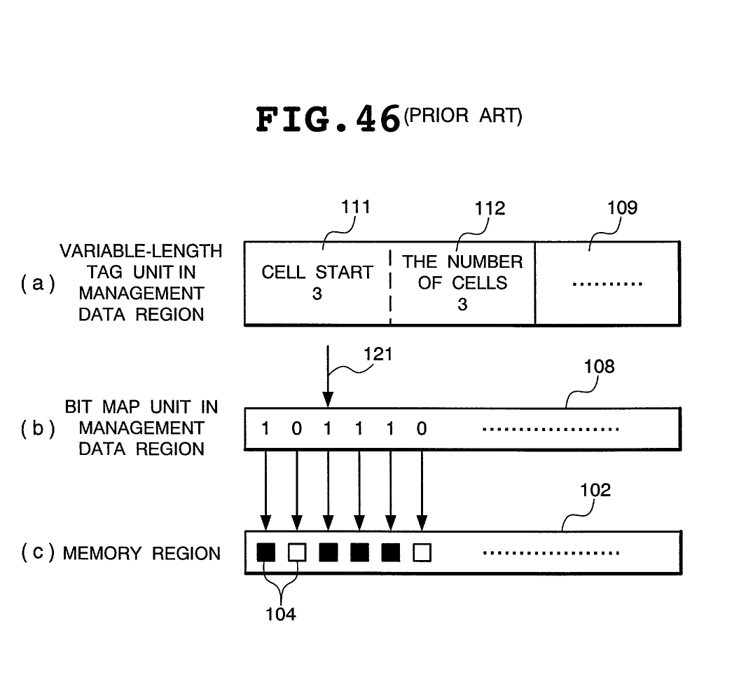

Prior to description of embodiments of the present invention, the principle of the present invention will be described. While in the description of FIG. 45, the memory cell 104 in the memory region 102 has only one kind, in the present invention, the same is assumed to be a set of memory cells of a plurality of sizes. Then, the respective kinds of memory cells have a hierarchical structure.

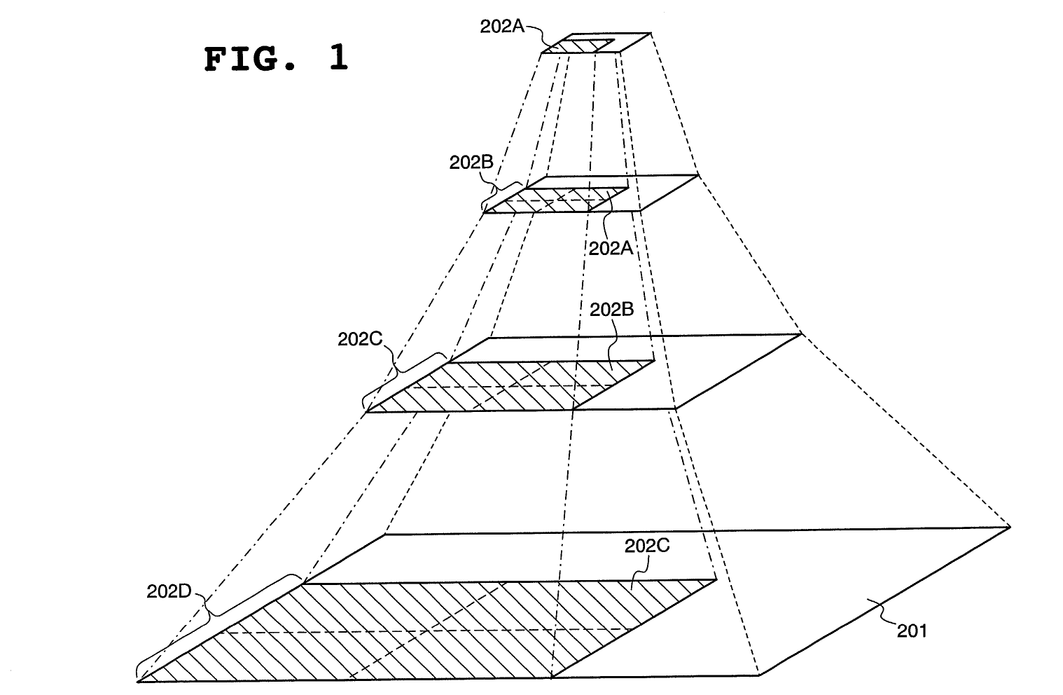

FIG. 1 illustrates a structure of a memory cell according to the present invention. When memory cells of a plurality of layers are to be set in a memory region 201 to be managed, variation in size of data as a target of ensuring and releasing which is requested of this memory management device should be taken into consideration. In a case where variation is very small or where sizes of data to be handled are all fixed, adopting one size of a memory cell shown in FIG. 45 which has been described above and matching the size with a size of data to be handled realizes efficient memory management.

A memory management device or a memory management method of the present invention is premised on a case where a size of target data largely varies. In the present invention, on this premise, consider one unit of data volume that is handled by a smallest size memory cell for the whole of the memory region 201 managed. Then, assume a data volume equal to or a little larger than the above data volume and easy to be managed to be a memory cell 202A as the smallest unit. Then, define a memory cell of a size easy to manage such as four times or eight times the smallest unit of the memory cell 202A and set the memory cell to be a memory cell 202B whose data volume is the second largest. In FIG. 1, the memory cell 202B having the second-largest volume of data is a region whose volume of data is four times that of the memory cell 202A as the smallest unit.

When the size of the requested data is larger even than the memory cell 202B whose volume of data is the second largest, define a memory cell having a multiplication (four times in this example) predetermined with respect to the memory cell 202B whose volume of data is the second largest based on the same principle and make the same as a memory cell 202C whose volume of data is the third largest. Accumulate layers in the same manner. In the example shown in FIG. 1, a memory cell 202D whose volume of data is the fourth largest will be the largest memory cell.

In the embodiment to be described in the following, memory cells are divided into three layers and the largest-size memory cell is referred to as a first bit string. Then, less smaller and the smallest memory cells are referred to as a second bit string and a third bit string, respectively. Thus, depending on to which size the smallest bit string is set and on how many times the size of the smallest bit string is set to be to correspond to the largest data, a depth of a hierarchy of a memory cell changes.

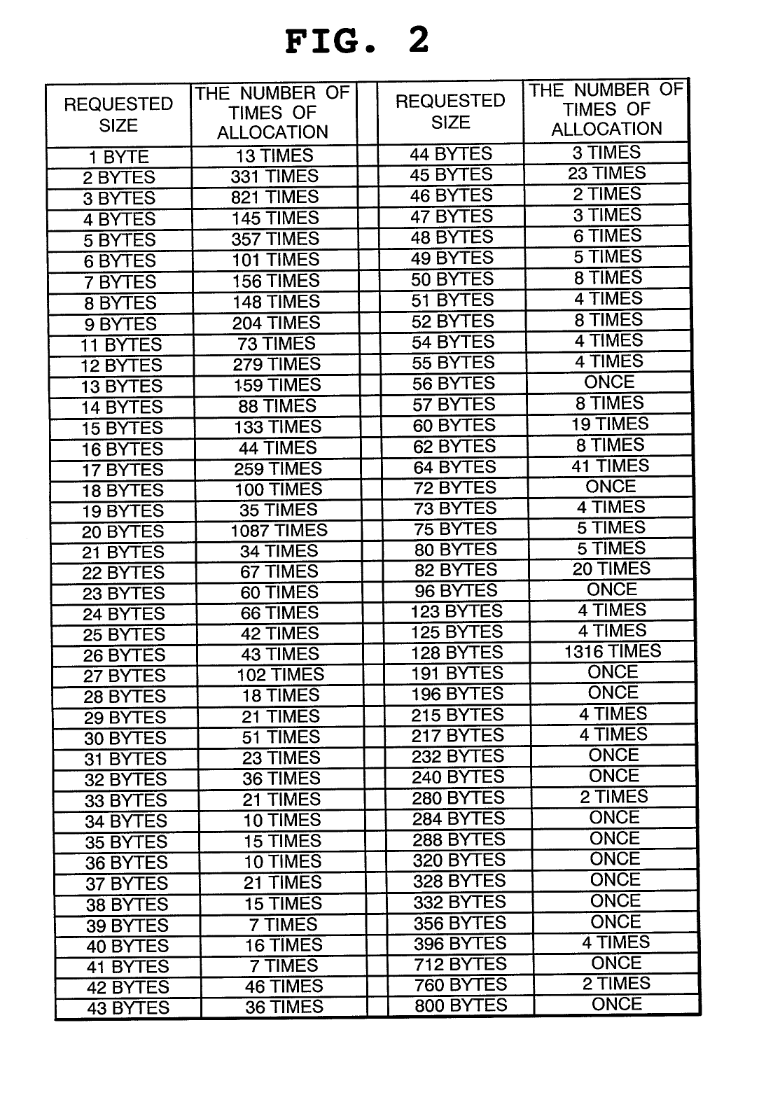

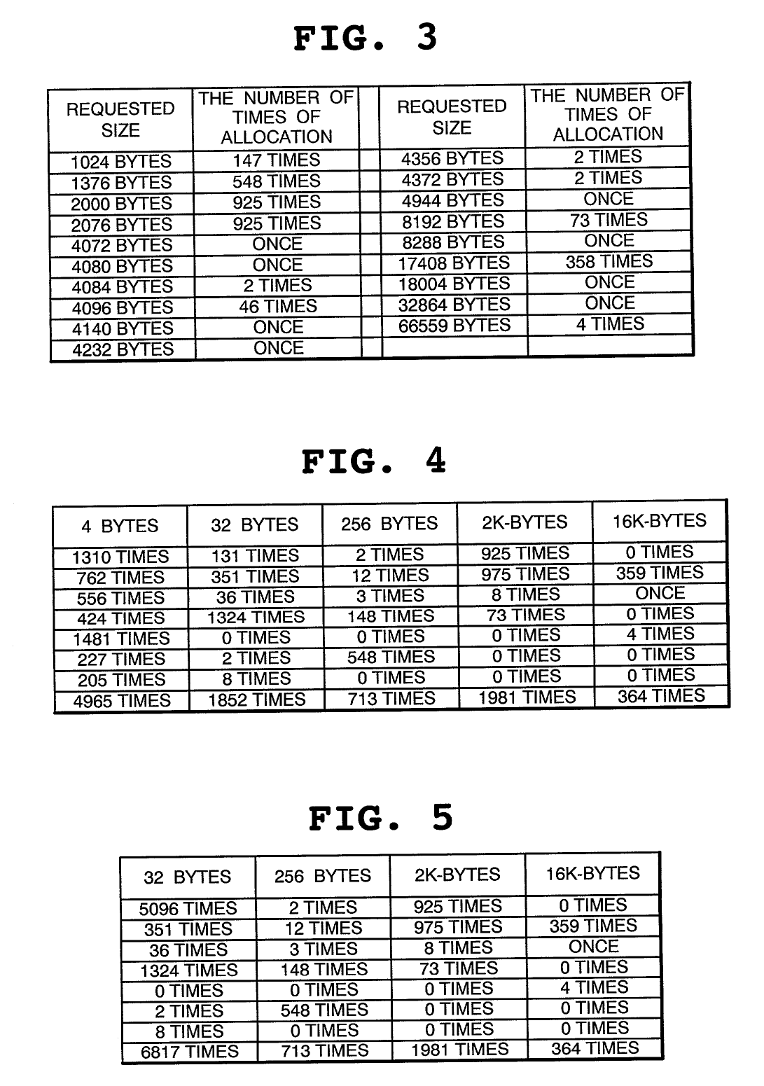

FIGS. 2 and 3 show one example, in two parts of the first half and the latter half, of sizes requested (requested size) of memory in a system to which the memory management device is applied and the number of times of allocation of a memory region at the respective requested size. This is one example of execution of a UNIX application, in which a lapse of ten minutes is listed. As can be seen in the figure, at such memory sizes whose volume of data is small as 2 bytes and 3 bytes and at such sizes whose volume of data is large as 1024 bytes to 17408 bytes, a request for memory allocation is made many times. Also at such medium sizes as 20 bytes, 128 bytes and 1024 to 2076 bytes, a memory allocation request is frequently made.

Moreover, a range of sizes requested at one time is extremely wide, from one byte to 66559 bytes. In such a case as this example, therefore, similarly to the conventional technique shown in FIG. 45, setting data small to some extent to have a size of one unit of memory cell and applying the variable-length tag unit 109 to data of a size larger than the former data will lead to abnormal increase in the number of times of application of the variable-length tag unit 109 to prevent efficient memory management.

FIG. 4 shows, with respect to a memory access state of the examples shown in FIGS. 2 and 3, the frequency of access of each layer in a case where a hierarchical structure of the memory cell has five layers. Shown in this example is a management structure having five layers, larger by one layer than that having the four layers shown in FIG. 1. On the other hand, FIG. 5 shows, with respect to a memory access state of the examples shown in FIGS. 2 and 3, the frequency of access of each layer in a case where a hierarchical structure of the memory cell has four layers. This is the same in the number of layers as that described with reference to FIG. 1. In general, as the number of layers is increased, the volume of data of a management data region for managing a memory region is increased. However, in a case where data size largely varies, each size of data can be individually coped with by increasing the number of layers, whereby processing speed is improved. It is therefore necessary, taking the two factors into consideration, to set the size of a smallest memory and the number of layers. Specific consideration will be here given to a state of management of the memory region when a request for data of various kinds of sizes is made.

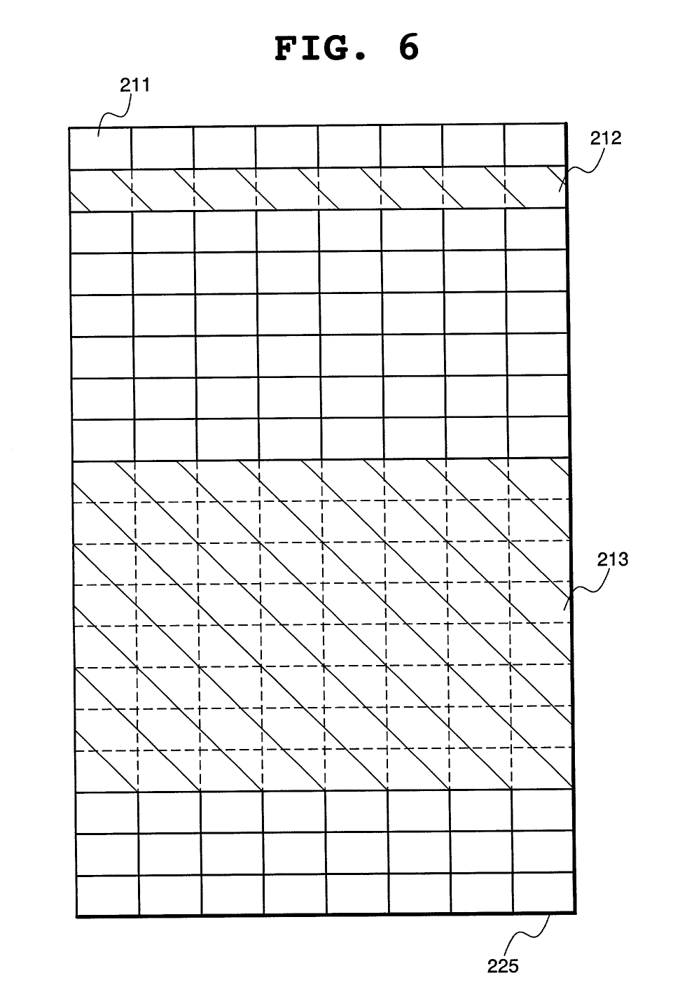

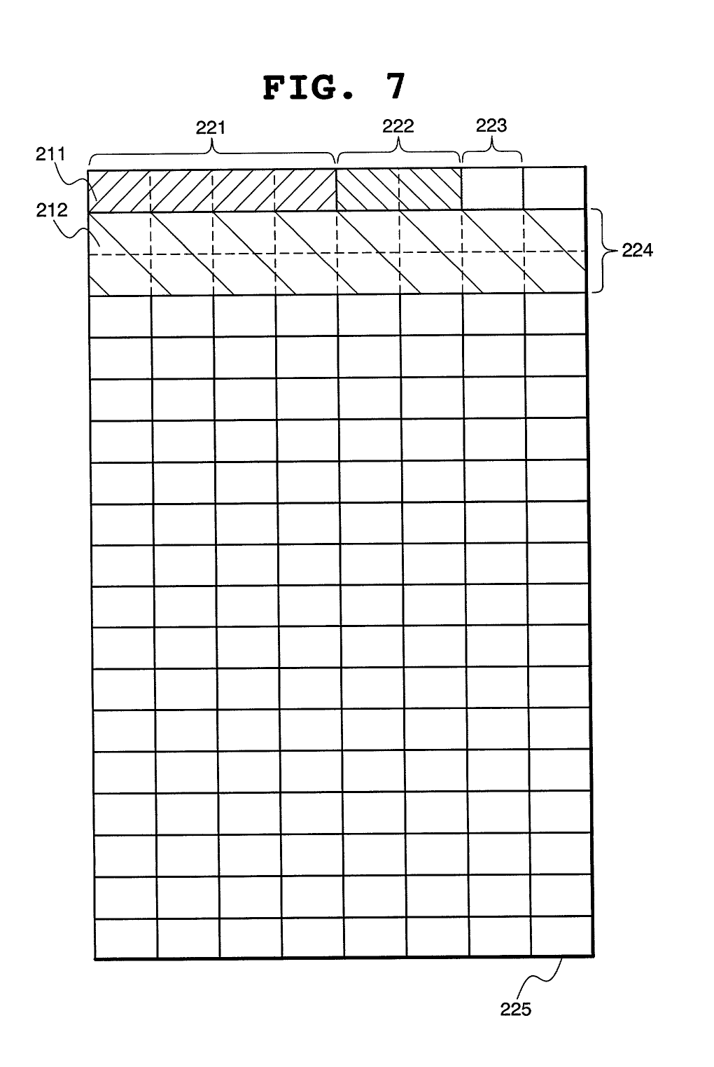

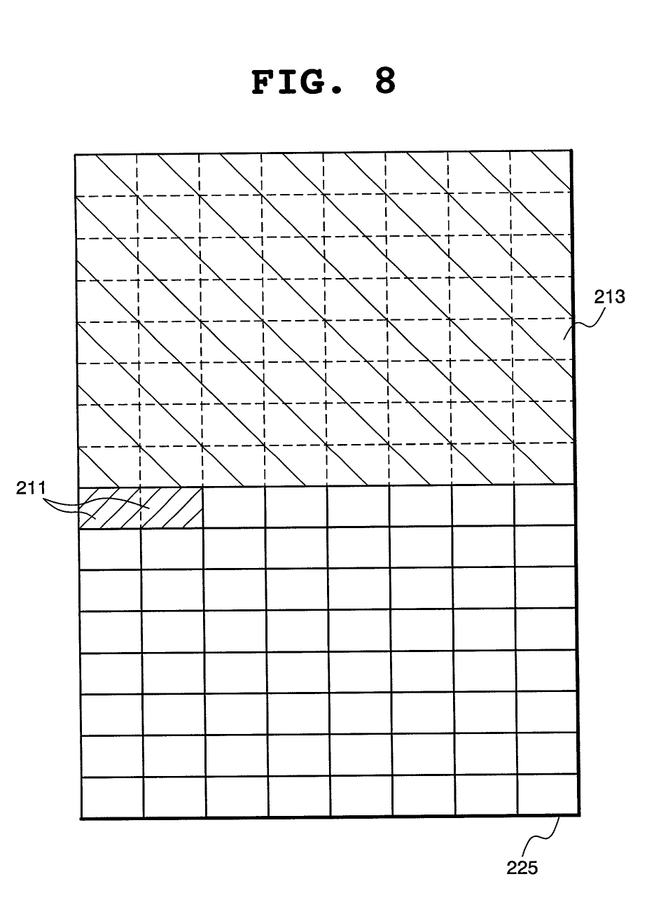

FIG. 6 shows a case where a hierarchical structure of memory cells has three layers. Here, there exist a memory cell 211 having the smallest size, a memory cell 212 having a medium size and a memory cell 213 having the largest size. The medium-size memory cell 212 is equivalent to eight of the smallest-size memory cells 211 and the largest-size memory cell 213 is equivalent to eight of the medium-size memory cells 212. In other words, the largest-size memory cell 213 is equivalent to 64 of the smallest-size memory cells 211.

FIG. 7 shows one example of memory cells in a case where data is ensured by a memory management device having the hierarchical structure shown in FIG. 6. In this example, a memory region 225 is allocated to data 221 equivalent to four of the memory cells 211, to data 222 equivalent to two of the same, to data 223 equivalent to one of the same and data equivalent to two of the memory cells 212. Assume that memory size is defined only one kind, for example, the size of the memory cell 211. In such a case, find a place where 16 of the memory cells 211 in a row are not in use and allocate the place as the memory region 225. Moreover, when data equivalent to the largest-size memory cell 213 shown in FIG. 6 is allocated to the memory region 225, it is necessary to find a place where 64 of the memory cells 211 are not in use in a row.

On the other hand, in a case where layers of the memory cells 221 to 223 are set, when, for example, ensuring a memory region for the data equivalent to two of the memory cells 212, it is not necessary to find a place where 16 of the memory cells 211 are not in use in a row but to find a place where two of the memory cells 212 are free in a row.

FIG. 8 shows an example of processing to be conducted when a request for ensuring a memory region whose volume of data a little exceeds a capacity of the largest-size memory cell. As illustrated in the figure, for the volume of data a little exceeding the capacity of the largest-size memory cell 213, only by adding a necessary number of the smallest-size memory cells 211 to the memory cells 213, a desired memory region can be ensured. Thus, if a plurality of stages of memory cells whose capacity is approximate to a size of region to be ensured are provided, speed of searching a free region of a memory region and processing of management data will be increased. Although the largest size and the smallest size are illustrated here, memory cells are not limited thereto. In general, the same method can be adopted according to a relationship between a memory cell having a relatively large size and a memory cell having a relatively small size.

Setting a memory size to have a hierarchical structure makes a memory region less liable to have a fragment. This is because depending on a volume of data allocated, segregative use of a region at which data is stored in a memory region is possible. Assume, for example, the following operations are conducted at the memory region 225 at an initial state where no data is stored.

(1) ensure one memory cell 211

(2) ensure one memory cell 213

(3) ensure one more memory cell 211

(4) release one memory cell 213

(5) ensure one memory cell 211

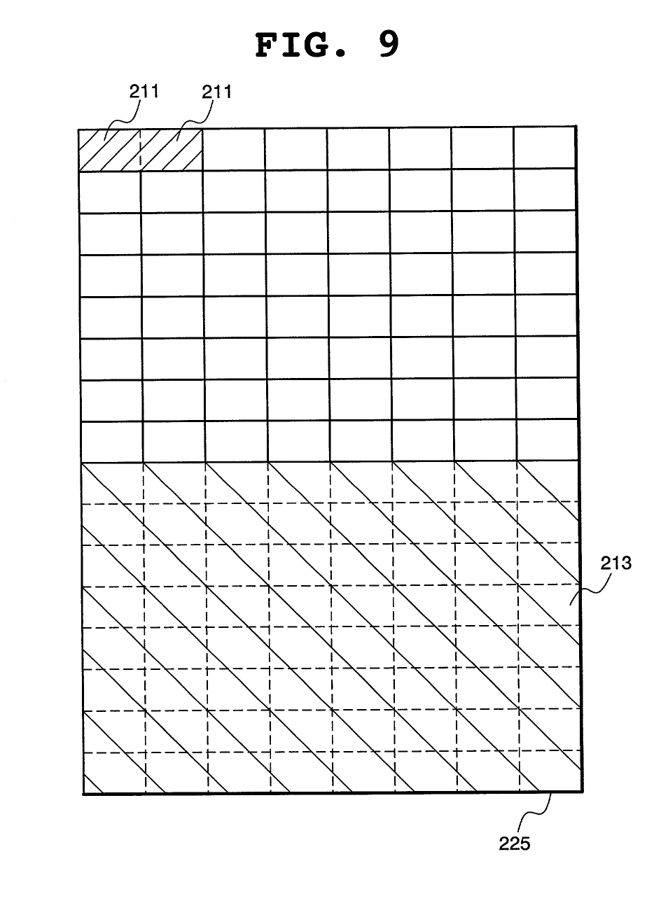

At a time when of the above operations, operations (1) to (3) are completed, such a memory occupation state as illustrated in FIG. 9 is obtained.

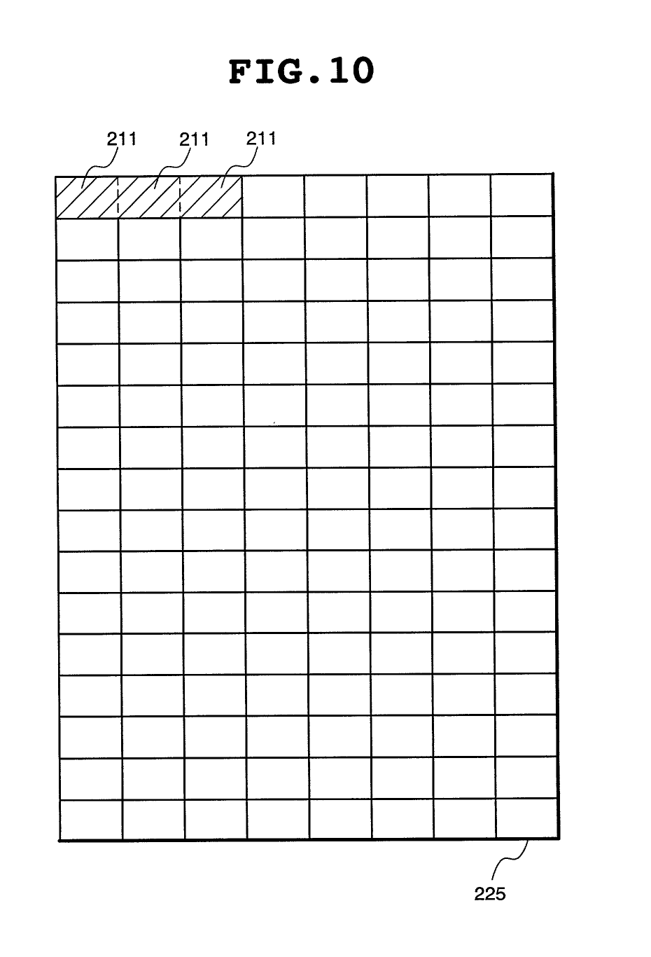

FIG. 10 shows a state obtained after the operations (4) and (5) are further conducted at the state illustrated in FIG. 9. The present situation will be compared with that of a conventional case where a memory size is only one kind, the memory cell 211.

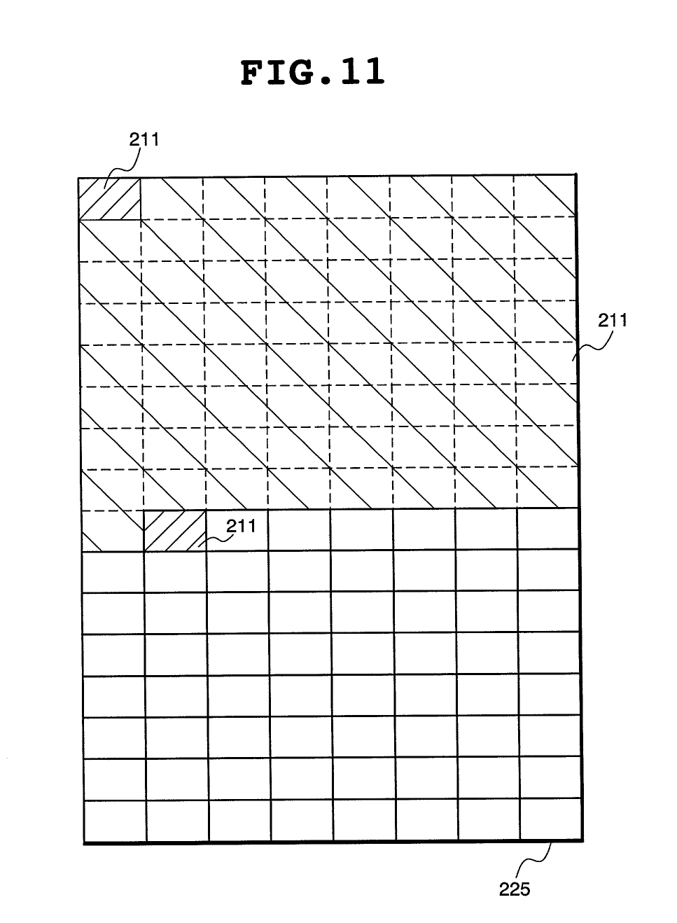

FIG. 11 shows a state of memory occupation at a time when the operations (1) to (3) are completed in the conventional case where a memory size is only one kind, the memory cell 211. First, by the operation (1), the memory cell 211 is ensured with a leading address in the memory region 225 as a starting point. Then, by the operation of (2), 64 of the memory cells 211 equivalent to one memory cell 213 are sequentially ensured, starting at an address of a free region near the head. Lastly, by the operation of (3), one memory cell 211 is ensured from an address of a free region near the head.

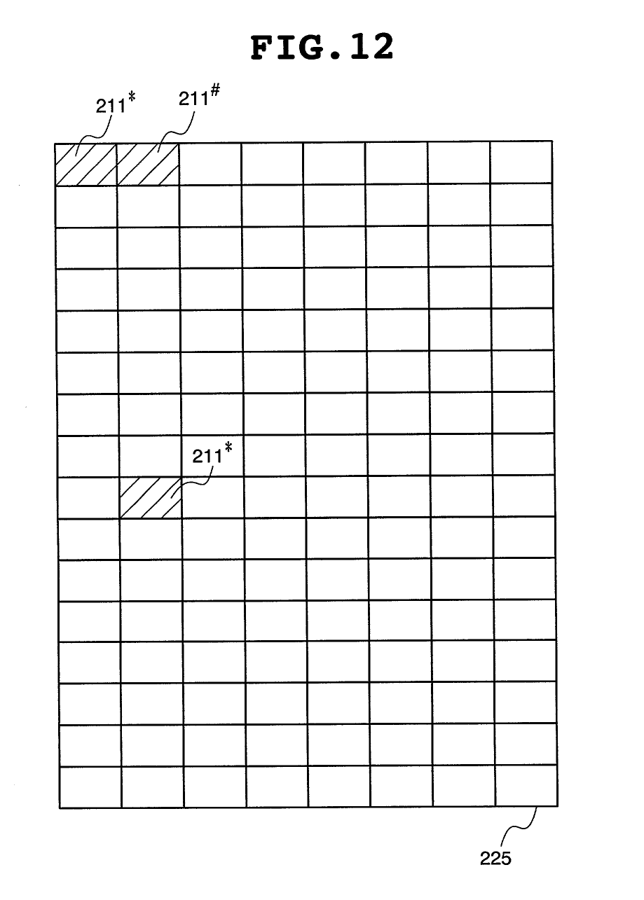

FIG. 12 shows a memory occupation state obtained at a time when the operations (4) and (5) are completed. When the memory region of 64 memory cells in FIG. 11 is released by the operation (4), the two of the memory cells 211 with * attached thereto occupy the memory region 225 in FIG. 12. For ensuring a region of one memory cell 211 by the operation (5), memory regions are sequentially ensured starting at a free region near the head. Accordingly, the memory cell 211 with # attached thereto is newly allocated. More specifically, at a stage where relatively large data is released from the memory region 225, if data is stored at the subsequent address, the memory cell 211 is left at the original position. In addition, at a memory region in-between released from the memory region 225 (a region of 64 of the memory cells 211), data smaller in size will be stored from the head, so that a possibility that the free region will be occupied efficiently enough is lowered and fragment is more liable to be generated. In the example shown in FIG. 12, since the memory cell 211 with # attached thereto is newly allocated, even when a request for allocating data equivalent to 64 of memory cells 211 is again made, data can not be stored in the previous free region.

In addition to designing a memory cell to have such a hierarchical structure as shown in FIG. 1, by elaborating a memory region searching direction and a search starting potion at the time of allocation of a memory cell, efficient memory management coping with various scenes can be realized. Changing a memory region searching direction and a search starting position alternately so as to have the memory cell size increased or decreased will be considered. Such arrangement facilitates memory cells of the same size (layer) to concentrate on the same place. When the number of times of memory allocation at each layer averages, fragmentation is less liable to occur.

First, description will be made of alternate change of a memory region searching direction at the time of memory cell allocation. Alternate change implies that in a case where memory cells of three kinds of sizes exist, that is, the above-described smallest-size memory cell 211, medium-size memory cell 212 and largest-size memory cell 213 exist, with respect the memory cell 211 and the memory cell 213, for example, search is conducted in the ascending order of addresses starting at a lower address and with respect to the memory cell 212, the same is conducted in the descending order starting at a higher address. The direction of ensuring the memory cells 211 to 213 may be the direction exactly opposite thereto. Also when memory cells have more than three kinds of sizes, the same idea can be adopted.

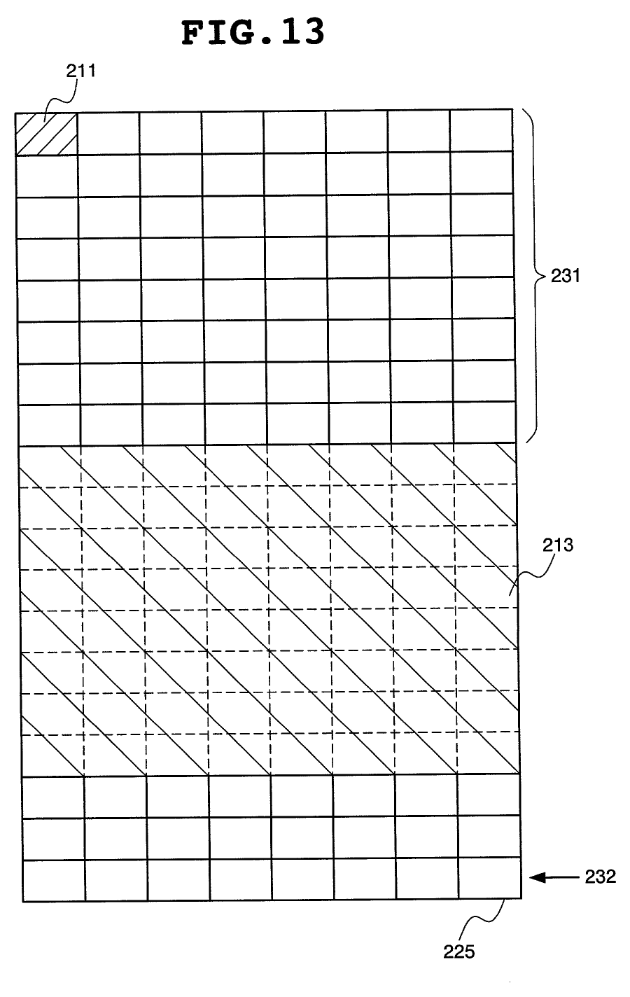

FIG. 13 is a diagram for use in explaining actual alternate setting of a memory region searching direction in a memory management device having a hierarchical structure in which a memory cell has an eight-fold increase each in size. The state shown in FIG. 13 appears, for example, when at the state shown in FIG. 6, the medium-size memory cell 212 is released. When at the state shown in FIG. 13, a request for ensuring the smallest-size memory cell 211 is made, the memory cell is ensured at the right side of the place where the memory cell 213 is stored in the figure.

When ensuring the medium-size memory cell 212 is requested, not as a result of allocation to a free region 231 equivalent to 63 of the smallest-size memory cells 211 at the state shown in FIG. 13 but as a result of setting starting at a larger address of the memory region 225, one column indicated by an arrow 232 (a region equivalent to eight memory cells 211) is allocated. As a result, the free region 231 in the figure will be an area exclusively for the smallest-size memory cell 211, so that before this region is wholly occupied, the memory cell 211 of this size will not be allocated to other region.

Also when releasing the regions of the memory cells 211 to 213, at a time when subsequent memory cell ensuring is conducted, the possibility that a memory cell region will be ensured in a region where memory cells of the same size concentrate is increased. Assume, for example, that after the free region 231 in the figure is all occupied by the smallest-size memory cells 211, one region of the memory cell 211 among them is released, the region will be used for ensuring a region of other memory cell 211 of the same size. Also when a region of the medium-size memory cell 212 is released, since the search direction is opposite to that of the smallest-size memory cell 211, the possibility that the released region will be newly occupied by the memory cell 211 is very low. In addition, in this example, the smallest-size memory cell 211 and the largest-size memory cell 213, two stages larger in size, have a 64-fold size difference. It is accordingly impossible, even when the free region 231 at the state shown in FIG. 13 is generated, to ensure this area smaller in size than the largest-size memory cell 213. By thus alternately setting a memory region search direction and a search staring position, segregative use of the memory cells 211 to 213 according to their sizes is enabled. This signifies that fragmentation is less liable to occur to enable efficient use of memory.

Next, description will be made of a point that elaborating a search starting position at the time of allocating a memory cell makes fragmentation be less liable to occur.

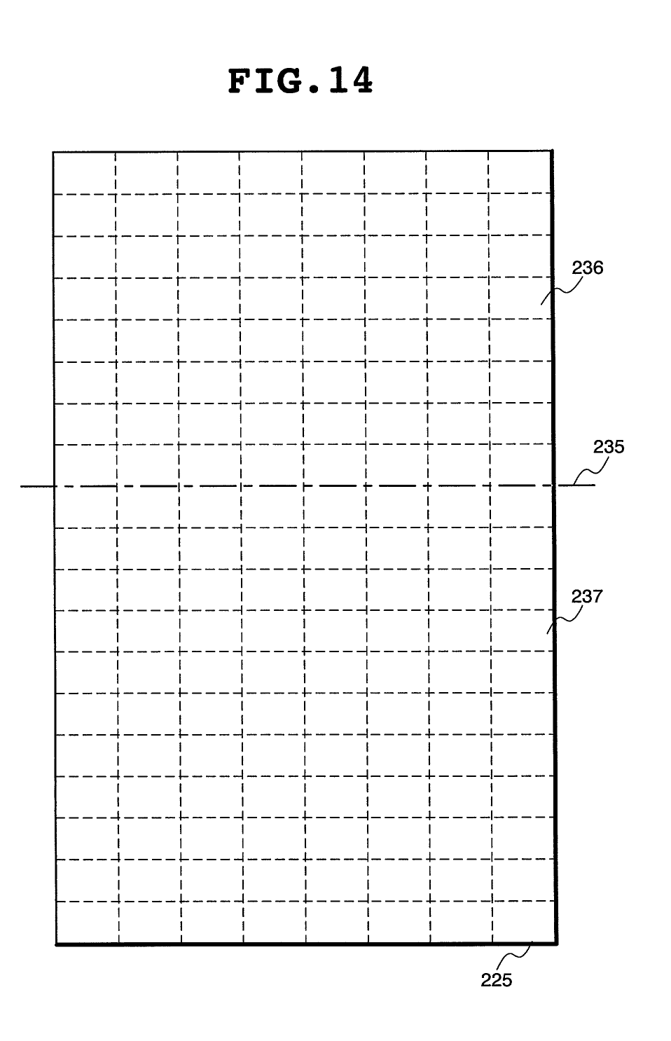

FIG. 14 shows a relationship between a boundary position and a memory cell for elaborating a search starting position. In the figure, the memory region 225 is divided into two with a predetermined address as a boundary 235 as a border. In this example, assuming that memory cells have four kinds of sizes, a first-smallest-size memory cell and a second-smallest-size memory cell are arranged in a first half region 236 and a first-largest-size memory cell and a second-largest-size memory cell are arranged in a latter half region 237.

Thus setting a region decreases such a phenomenon that relatively small memory cells scatter and occupy the memory region 225 to result in making ensuring a region of a relatively large memory cell difficult. It is as a matter of course effective to alternately set search directions of memory regions of the first-smallest-size memory cell and the second-smallest-size memory cell in the first half region 236 and alternately set search directions of memory regions of the first-largest-size memory cell and the second-largest-size memory cell in the latter half region 237. In many cases, it is effective that the position of the boundary 235 is set at a place at which the total amounts of memory cells occupying the respective regions 236 and 237 are approximately the same.

Consideration will be given to such elaboration of a memory region search direction and a search starting position at the time of allocation of memory cells in relation to the above described FIGS. 4 and 5. First, in FIG. 4, the smallest-size memory cell has four bytes and a multiplication of a size of its adjacent memory cell is eight times, such as, four bytes to 32 bytes, 32 bytes to 256 bytes and 256 bytes to 2 K bytes.

In the UNIX application illustrated in this example, since allocation of the first, the third and the fifth layers, and that of the second and the fourth layers are equal, the alternate setting of a memory region search direction shown in FIG. 13 enables fragmentation to be less liable to occur. Also, the method of elaborating a search starting position shown in FIG. 14 enables fragmentation to be similarly less liable to occur.

On the other hand, in the example shown in FIG. 5, the smallest memory cell has the size of 32 bytes and a multiplication of a size of its adjacent memory cell is eight times such as, 32 bytes to 256 bytes and 256 bytes to 2 K bytes. In this example, allocation in each layer is not equal in the first and the third layers and between the second and the fourth. Therefore, the method of alternately setting memory region search directions shown in FIG. 13 is not appropriate. On the other hand, since the amount of allocation in each layer is equal between the first and the second layers and between the third and the fourth, use of the method of elaborating a search stating position shown in FIG. 14 enables generation of fragment to be less liable.

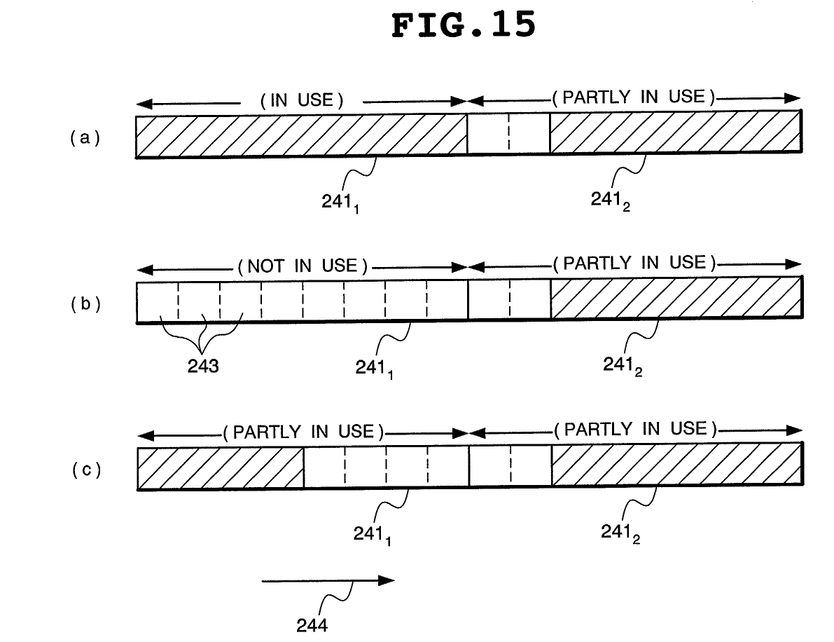

FIG. 15 is a diagram for use in explaining outlines of one of memory cell management methods adopted in the present invention. FIGS. 15(a) to 15(c) each show two successive memory cells 241₁ and 241₂ in a certain layer. These memory cells 241₁ and 241₂ are each composed of one-order lower eight memory cells 243. Here, for explanation sake, the memory cells 241₁ and 241₂ will be referred to as the higher-order memory cells 241₁ and 241₂ and the memory cell 243 will be referred to as the lower-order memory cell 243.

Because in the higher-order memory cell 241₁ of FIG. 15(a), all the lower-order memory cells 243 are used, it will be referred to as being “in use”. Because in the higher-order memory cell 241₂of FIG. 15(a), a part of the lower-order memory cells 243 are used, it will be referred to as being “partly in use”. Because in the higher-order memory cell 241₁ of FIG. 15(b), all the lower-order memory cells 243 are yet to be used, it will be referred to as being “not in use”.

Assume now that at a state where a certain higher-order memory cell 241₁ is “in use” and the subsequent higher-order memory cell 241₂ is “partly in use” as shown in FIG. 15(a), the higher-order memory 241₁ is released at the subsequent step to enter the “not in use” state as shown in FIG. 15(b). Assume that thereafter, allocation of five of the lower-order memory cells 243 is requested to conduct scanning of a free region equivalent to five successive lower-order memory cells 243 in a direction indicated by an arrow 244 in the figure.

In this case, in the first method of the present invention for searching a region where five lower-order memory cells 243 exist in a row, scan one-order higher memory cells at the state of “not in use” or “partly in use” in the direction of the arrow 244 to find a place which includes a region equivalent to or larger than the region of five successive memory cells. The advantage of this method is that since management is conducted using memory cells higher in order than each eight memory cells 243 set to be “in use”, checking for the eight cells can be omitted to shorten a time for finding a target free region. Then, in a case where not more than four of the lower-order memory cells 243 are requested, for example, it is possible to set the lower-order memory cells 243 at a place of the higher-order memory cell 241₁ in FIG. 15(c).

However, in such a case of finding a region of five successive lower-order memory cells 243 as this example, first, in the higher-order memory cell 241₁, check a free region following the four lower-order memory cells 243 in use in the figure from the left end to the right end and find only four lower-order memory cells 243 to give up allocation to this part. Similarly, in the subsequent higher-order memory cell 241₂, check a free region before the starting point of the lower-order memory cell 243 in use from the left end of the figure and find two lower-order memory cells 243 in this place to give up allocation to this part. Thus find a place in the higher-order memory cell 241 not shown in the figure where a free region in which not less than five lower-order memory cells 243 exist and allocate five lower-order memory cells 243.

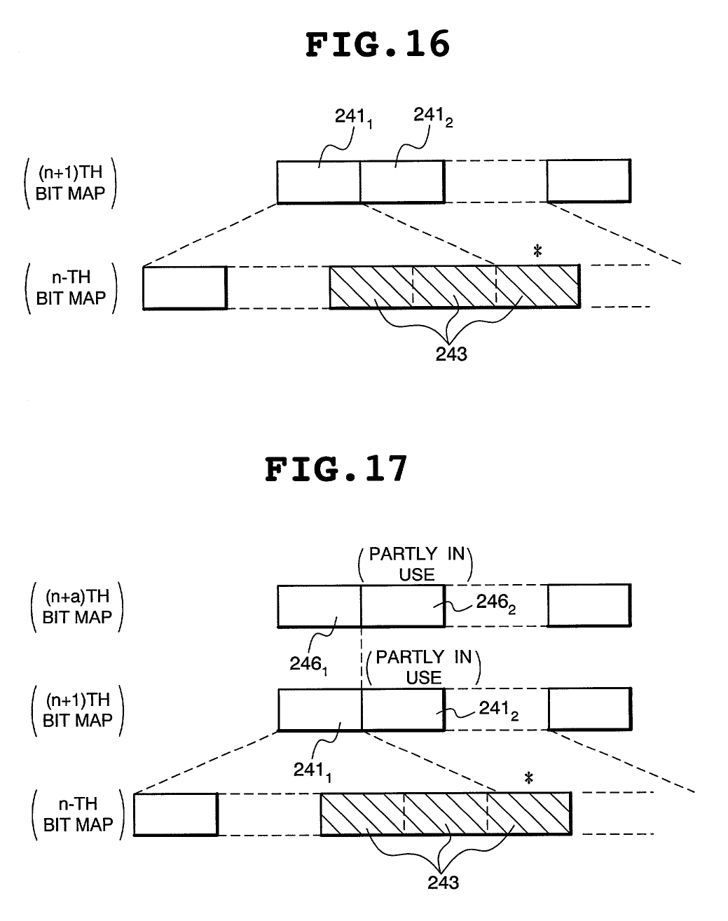

FIG. 16 is a diagram for use in explaining outlines of another memory cell management method of the present invention. Again with reference to FIG. 15(c), the method is finding a free region lying over adjacent parts of two higher-order memory cells 241₁ and 241₂ adjacent to each other and considering the region as successive free regions to use the regions for the allocation of a plurality of successive lower-order memory cells 243.

FIG. 16 shows an example that lower-order memory cells 243 are arranged over two higher-order memory cells by such a memory cell management method as mentioned above. In this example three lower-order memory cells 243 are arranged in free regions. As a result, efficient use of adjacent parts of the two higher-order memory cells 241₁ and 241₂ is enabled.

This method has not only such an advantage as mentioned above but also a problem. As will be described later, assume that a bit map indicative of a state of each memory cell in each layer is prepared. Here, assume that an (n+1)th bit map is prepared for higher-order memory cells 241₁, 241₂, . . . and an n-th bit map is prepared for the lower-order memory cell 243. With the bit maps prepared, attach state identification data indicative of such states, “in use”, “partly in use” and “not in use” as already described to each memory cell.

In this case, in terms of prevention of generation of fragments, in many cases more effects are obtained when change of a relatively lower-order memory cell such as the lower-order memory cell 243 causes no change in a bit map of a higher memory cell (in this example, the higher-order memory cells 241₁, 241₂, . . . or further higher-order memory cells).

In a case of the example shown in FIG. 16, assume, because one (indicated by * in the figure) of the newly allocated three lower-order memory cells 243 lies over the higher-order memory cell 241₂, the higher-order memory cell 241₂ is at the state of “not in use”, it should be changed to the state of “partly in use”. Such change implies that depending on a state of an adjacent higher-order memory cell 241₃ not shown, memory cells having a size equivalent to eight lower-order memory cells 243 might not be arranged over the higher-order memory cell 241₂ and its adjacent part. In other words, a free region might be divided.

FIG. 17 is a diagram showing an example that when the method shown in FIG. 16 is adopted, a large change is caused in a higher-order bit map. Shown here is a state where because one (indicated by * in the figure) of the newly allocated three lower-order memory cells 243 lies over the higher-order memory cell 241₂ as in FIG. 16, even a memory cell 246₂ higher in order by one or a plurality of layers is changed from “not in use” to “partly in use” as a chain reaction. In such a case, it will be more difficult to ensure a memory space for a larger memory cell than the case described in FIG. 16.

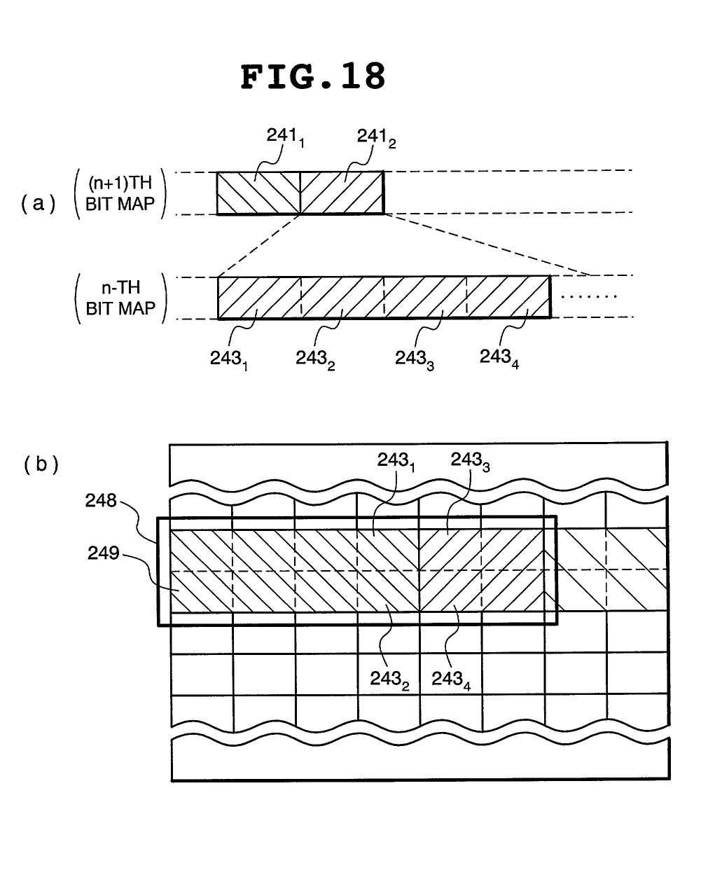

FIG. 18 is a diagram showing another example of allocation of a memory space in a memory region. Here, two adjacent higher-order memory cells 241₁ and 241₂ are observed as shown in FIG. 18(a). Assume that a request is made for ensuring a memory region 248 (FIG. 18(b)) larger in size than one of these higher-order memory cells 241₁ and 241₂ and smaller than two of the same. When such a request is made for the memory region 248 whose size is not less than one and less than two of the higher-order memory cells 241₁ and 241₂, ordinarily ensure two higher-order memory cells 241₁ and 241₂. Then, to a management data region (see the management data region 103 of FIG. 45) indicative of a state of memory ensured, a checked change state of a memory cell further higher in order than the two higher-order memory cells 241₁ and 241₂ is notified.

Assume, for example, that a whole area 249 of the higher-order memory cell 241₁ and first to fourth lower-order memory cells 243₁ to 243₄ in the higher order memory cells 241₂ adjacent to the area 249 are ensured as the requested memory region 248. In the case of this example, the higher-order memory cell 241₁ is changed from the state of “not in use” to the state of “in use” and in some of the systems, it is changed not to simple “in use” state but to a state of in use as the “head of allocation”. As to the higher-order memory cell 241₂ adjacent thereto, it is changed from “not in use” to “partly in use” or when it is already in the state of “partly in use” and this allocation brings all the lower-order memory cells 243 to the state of in use, it will be changed to “in use”. When the state of “partly in use” still continues, no state change is made. In addition, if allocation of a memory region to such two higher-order memory cells 241₁ and 241₂ causes a change of a state of a one-order higher memory cell, change of states such as “head of allocation” and “partly in use” will as a matter of course follow.

The reason why the concept of “head of allocation” has been described here in addition to “not in use”, “partly in use” and “in use” is that in an embodiment which will be described later, for clarifying a starting position of a memory cell, states of memory cells are defied by these four concepts (states).

Another advantage is that such four states can be defined using two bits.

The present invention will be described in detail with respect to embodiments in the following.

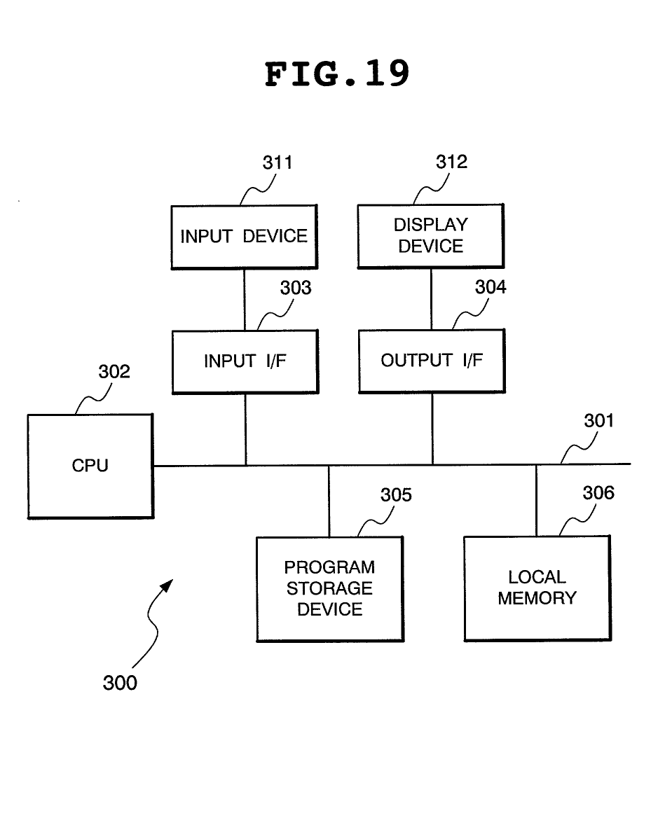

FIG. 19 is a diagram showing an entire structure of a memory management device according to one embodiment of the present invention. A memory management device 300 includes a CPU (central processing unit) 302 having a function as a core of the device. The CPU 302 is connected through a bus 301 such as a data bus to an input interface (I/F) 303, an output interface 304, a program storage device 305 and a local memory 306 of the present embodiment.

Of these components, the input interface 303 connects an input device 311 formed of a pointing device such as a mouse. The output interface 304 is connected to a display device 312 such as a CRT (Cathode Ray Tube) or a liquid crystal display. The interface is possibly connected to a printer not shown. The program storage device 305 is formed of, for example, a magnetic disk, an optical disk, or a RAM (Random Access Memory) and stores a program for functioning the memory management device and other programs. The local memory 306 is not necessarily be special but be any of a semiconductor memory, a magnetic disk, an optical disk and the like as long as it has a capacity enough for memory. The program storage device 305 can be used also as the local memory 306 as hardware as a matter of course.

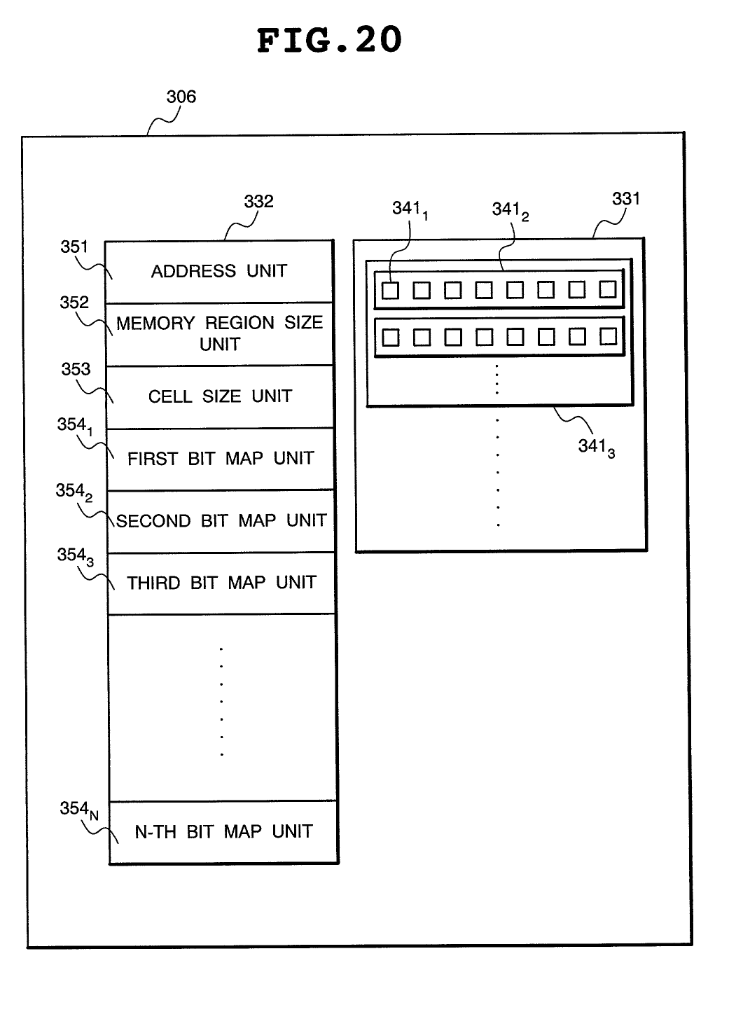

FIG. 20 is a diagram showing outlines of a structure of the local memory of the present embodiment. In the local memory 306 to and from which data is written and read by the CPU 302 shown in FIG. 19, a memory region 331 set for a user of memory and a management data region 332 for managing the memory region 331 are arranged. The memory region 331 has a first memory cell 341₁ whose size is the smallest as a fixed-length block dividing the region 331. A number N (N: positive integer) of the first memory cells 341₁ form a second memory cell 341₂. Similarly, the number N of the second memory cells 341₂ form a third memory cell 341₃. In the same manner, assuming a largest-size memory cell constituting the memory region 331 to be the N-th memory cell 341_{N}, a number (N−1) of the (N−1)th memory cells 341_{N-1} form the N-th memory cell 341_{N}.

On the other hand, the management data region 332 is made up of an address unit 351, a memory region size unit 352, a cell size unit 353 and first to N-th bit map units 354₁ to 354_{N}. Here, the address unit 351 indicates a leading address of the memory region 331. The memory region size unit 352 indicates the size of the memory region 331. The cell size unit 353 indicates the size of the first memory cell 341₁ which is the smallest as a fixed-length block. The first bit map unit 354₁ is composed of bit strings each having two bits indicative of an individual state of the first memory cell 341₁.

The second bit map unit 354₂ is composed of bit strings each having two bits indicative of a state of the second memory cell 341₂. In the same manner, the N-th bit map unit 345_{N} is composed of bit strings each having two bits indicative of a state of the N-th memory cell 341_{N} as the largest-size memory cell in the memory region 331. Taken here as the states are four, “head of allocation”, “not in use”, “partly in use” and “in use”. “Head of allocation” has its position varied as the memory cell search direction changes as a matter of course.

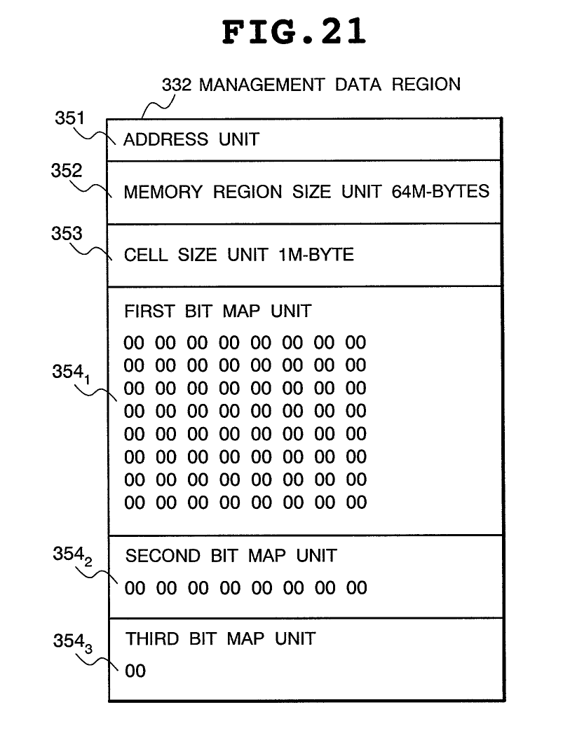

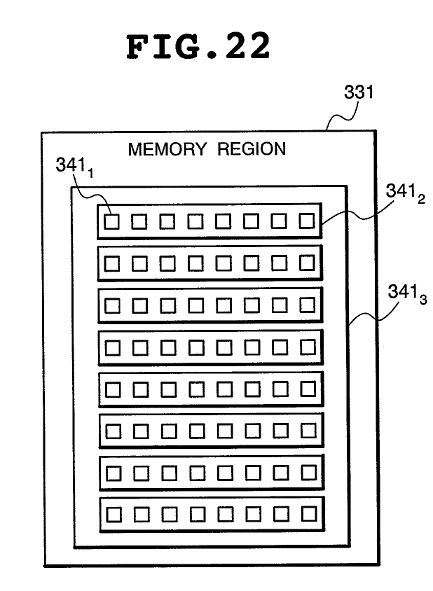

FIG. 21 is a diagram showing a structure of a specific management data region in a case where N of the N-th memory cell is “8”. FIG. 22 shows specific arrangement of the memory region in this case. In the memory region size unit 352 in the management data region 332 of FIG. 21, the volume of data of 64 M-bytes is set as the size of the memory region 331 shown in FIG. 22. At this time, as the smallest cell size constituting the memory region 331, the first memory cell 3411 is set to have 1 M-bytes as the smallest cell size constituting the memory region 331. As to the second memory cell 341₂, 8 M-bytes, the volume of data eight times that of the first memory cell 341₁, is set because N is “8”.

(FIRST PROCESSING OPERATION RELATED TO MEMORY MANAGEMENT)

Assume now that ensuring 2 M-byte memory is requested of a user of the local memory 306 (hereinafter, simply referred to as a user in ordinary cases excluding a special case) by the CPU 302 shown in FIG. 19. The CPU 302 calculates bit maps so as to efficiently manage the 2 M-bytes.

The first memory cell 341₁ has the size of 1 M-bytes and the second memory cell 341₂ has 8 M-bytes larger than 2 M-bytes. In this case, therefore, the first bit map unit 354₁ is set as a bit map for search. The necessary number of the first memory cells 341₁ is two.

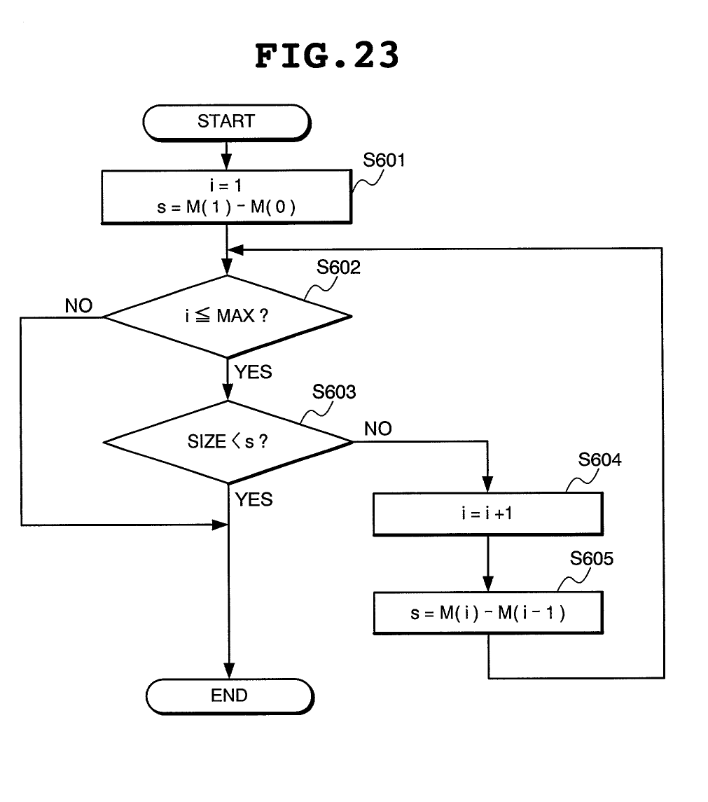

FIG. 23 shows a flow of processing for obtaining a structure of a layer to be managed (management layer) from a size of memory requested to be ensured. Assume that the maximum management layer to be managed by the memory management device is denoted as “MAX” and the size of memory requested as “size”. First, set a variable “i” indicative of a layer to be “1”, that is, to the first layer corresponding to the first memory cell 341₁, as well as setting the amount of memory “s” at the size of the first memory cell (Step S601). Here, the amount of memory “s” is the size of a memory cell in the first layer (1 M-bytes here).

Then, first determine whether the variable “i”, that is, “1” is smaller than the maximum management layer “MAX” (“3” here) or not (Step S602). When it is smaller (Y), check whether “size” of the memory requested (2 M-bytes here) is smaller than the size of the first-smallest first memory cell 341₁ (1 M-bytes here) or not (Steps S603).

When compared with the first-smallest first memory cell 341₁, it is not smaller (N). Therefore, the variable “i” is incremented by “1” to be “2” (Step S604). In addition, the amount of memory “s” is changed to “M(i)−M(i−1)”, that is, 6 M-bytes obtained by subtracting 2 M-bytes which is the size of the first memory cell 341₁ from 8 M-bytes which is the size of the second memory cell 341₂ (Step S605). Then, processing again returns to Step S602.

At Step S602, determination is made whether the variable “i”, i.e. “2” is smaller than the maximum management layer “MAX” (“3” here). In this case, it is smaller (Y), check whether “size” of requested memory (2 M-bytes here) is smaller than 6 M-bytes or not (Step S603). Since it is smaller, end processing of the layer to be managed. As a result, the layer of the first-smallest first memory cell 341₁ is considered as a target of management.

When at Step S602, the variable “i” exceeds the maximum management layer “MAX” (“3” here) (N at Step S602), end processing because of error.

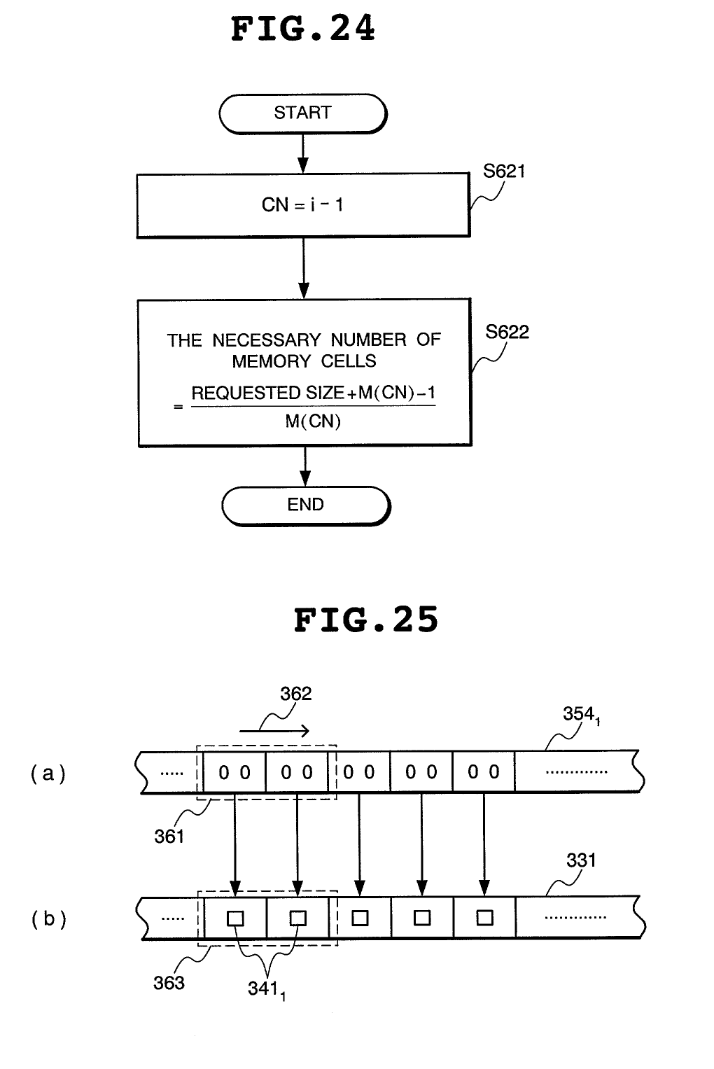

FIG. 24 shows a flow of processing of calculating the number of memory cells necessary in the management layer obtained in FIG. 23. For calculating the number of memory cells, first obtain a hierarchical structure number (CN). The hierarchical structure number is a result obtained by subtracting the numeric value “1” from the variable “i” as of the end of the processing in FIG. 23 (Step S621). Using the hierarchical structure number, the CPU 302 shown in FIG. 19 obtains the necessary number of memory cells (the first memory cell 341₁ here). Assuming the necessary number of memory cells to be NMU, the following expression (1) holds (Step S622).

NMU=[requested size+M(CN)−1]/M(CN) (1)

Putting actual values into this expression will have [2+M(1)−1]/M(1). Since M(1), which represents a memory size of a layer of the first-smallest first memory cell 341₁, is 1 M-bytes, the result will be 2/1, that is, 2. Operation of finding that the necessary number of the memory cells 341₁ in the first layer is two is thus conducted.

FIG. 25 shows a state of processing to be conducted after a request for ensuring 2 M-byte memory is made in the present embodiment. First, check whether there exists in the first bit map unit 354₁ shown in FIG. 25(a) a bit string indicative of two successive first memory cells 341₁ not in use for the 2 M-byte memory. Assume here that a bit string indicative of a memory cell partly in use is denoted as “01” and a bit string indicative of a memory cell not in use is denoted as “00”. The figure schematically illustrates how a frame 361 equivalent to two memory cells shifts in the direction indicated by an arrow 362 indicative of the direction of the bit string on a two-bit basis to check the existence of a region corresponding to two successive bits of the first memory cells 341₁ not in use.

Assume that as a result of such search, determination is made that a bit string indicative of two memory cells not in use exists at the place of the frame 361 illustrated in the figure in the first bit map unit 354₁. A memory block 363 composed of two successive first memory cells 341₁ not in use in the memory region 331 shown in FIG. 25(b) corresponds to the relevant bit string. Then, when as a result of the search by the two-bit frame 361, a bit string indicative of two memory cells not in use exists, the subsequent processing is conducted to check whether the two first memory cells 341₁ constituting the memory block 363 are really not in use.

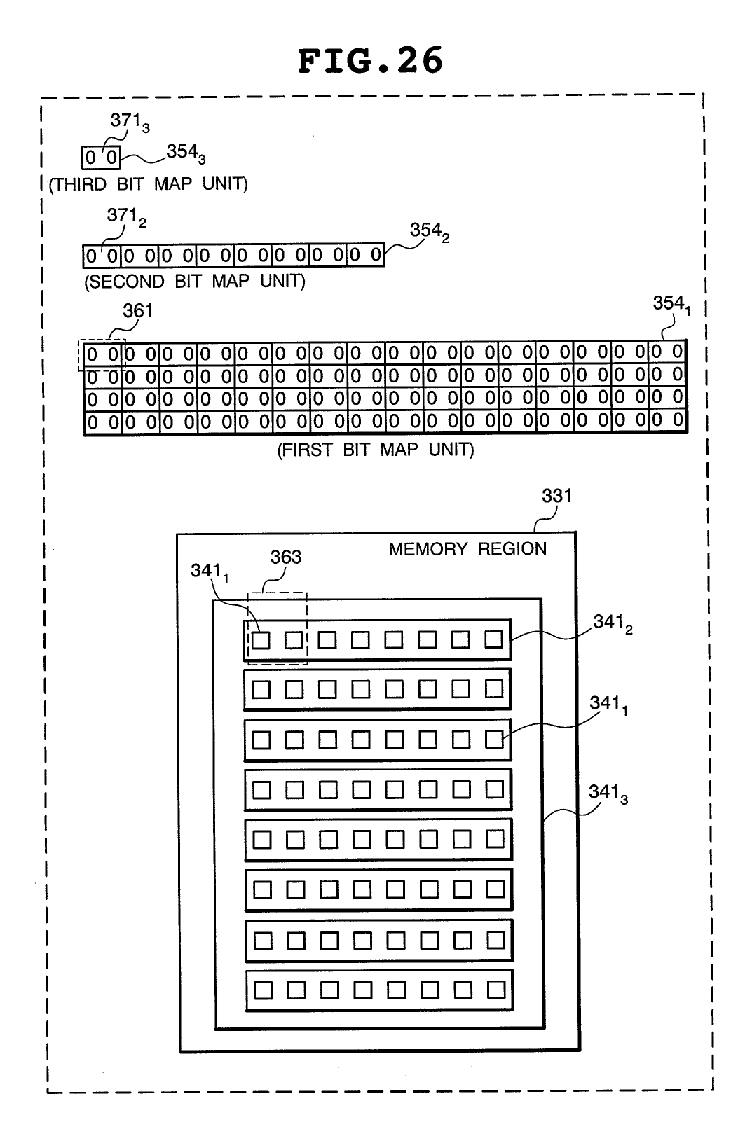

FIG. 26 shows the principle of the processing of checking whether each memory cell is not in use based on determination results obtained by the bit map unit. Illustrated in the figure are the first to third bit map units 354₁ to 354₃ and the first to third memory cells 341₁ to 341₃ in the memory region 331 in comparison. Assume a bit string which stores a state of the second memory cell 341₂ at the second bit map unit 354₂ to be a second bit string 371₂. Assume a bit string which stores a state of the third memory cell 341₃ at the third bit map unit 354₃ to be a third bit string 371₃. In this case, the two first memory cells 341₁ constituting the memory block 363 are not in use in either of the following cases:

(1) where the second bit string 371₂ is “00” indicative of the state of not in use and the third bit string 371₃ is “00” indicative of the state of not in use;

(2) where the second bit string 371₂ is “00” indicative of the state of not in use and the third bit string 371₃ is “01” indicative of the state of partly in use.

Assume that determination is made by the foregoing check that the memory block 363 is not in use. In this case, memory management is conducted so as to change the current state of the relevant memory block 363 to “in use”. In order thereto, change a bit string in the frame 361 in a bit map corresponding to the memory block 363 to “11 10”. Here, the first half two bits “11” form a bit string indicative of the head of a block used and the latter half two bits “10” indicate that the block is in use. Moreover, change the second bit string 371₂ as a bit string storing a state of the second memory cell 341₂ to “01” which indicates the state of partly in use. Similarly, change the third bit string 371₃ as a bit string storing a state of the third memory cell 3413 to “01” which indicates the state of partly in use.

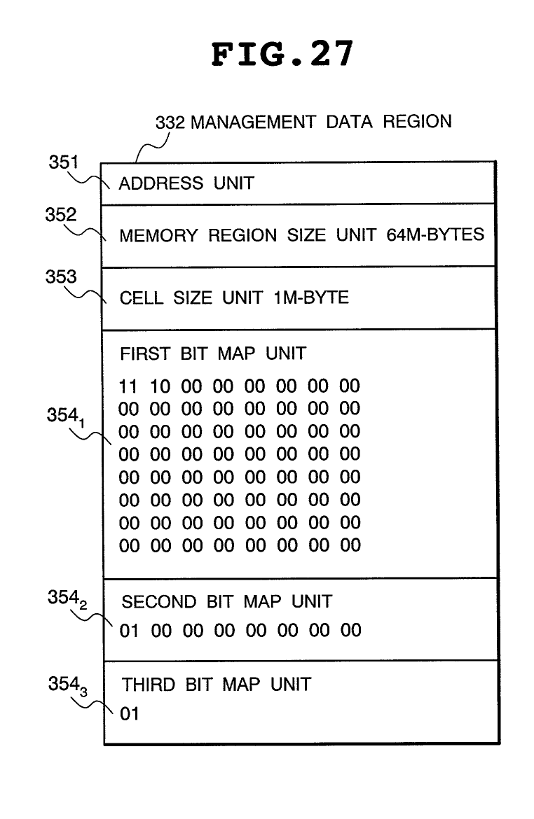

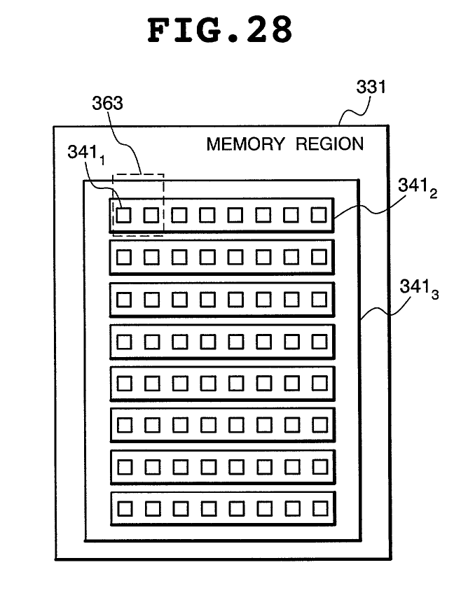

FIG. 27 shows a state of change of the management data region at a time when the foregoing processing is completed, while FIG. 28 shows a state of the memory region in which memory is ensured according to the change. In the first bit map unit 354₁ of the management data region 332 shown in FIG. 27, a bit string corresponding to the memory block 363 illustrated in FIG. 28 is changed to “11 10” as described above. In addition, a bit string at a corresponding position in the second bit map unit 354₂ and a bit string of the third bit map unit 354₃ are changed to “01” as mentioned above.

By transferring thus ensured memory block 363 to a user to respond to a memory ensuring request and by changing a bit string corresponding to the relevant first memory cell 341₁ in the bit map to the state of the head of a block used and the state of in use, allocation of the first memory cell 341₁ is realized.

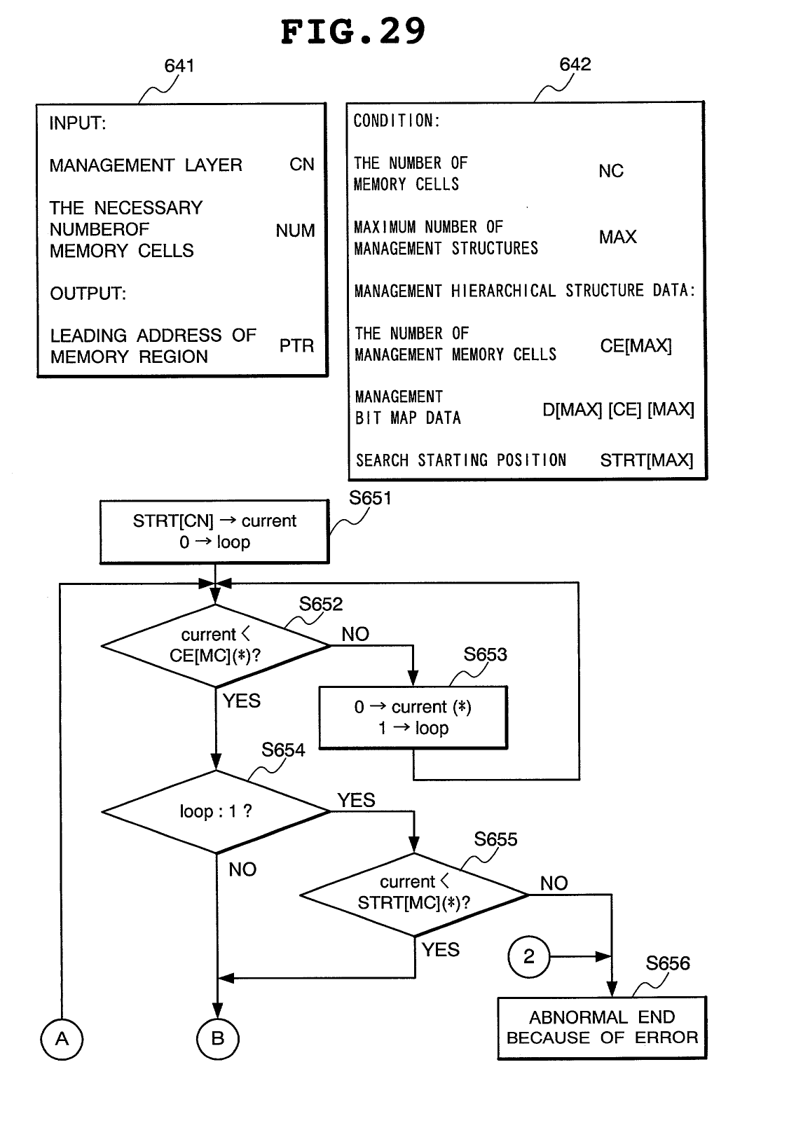

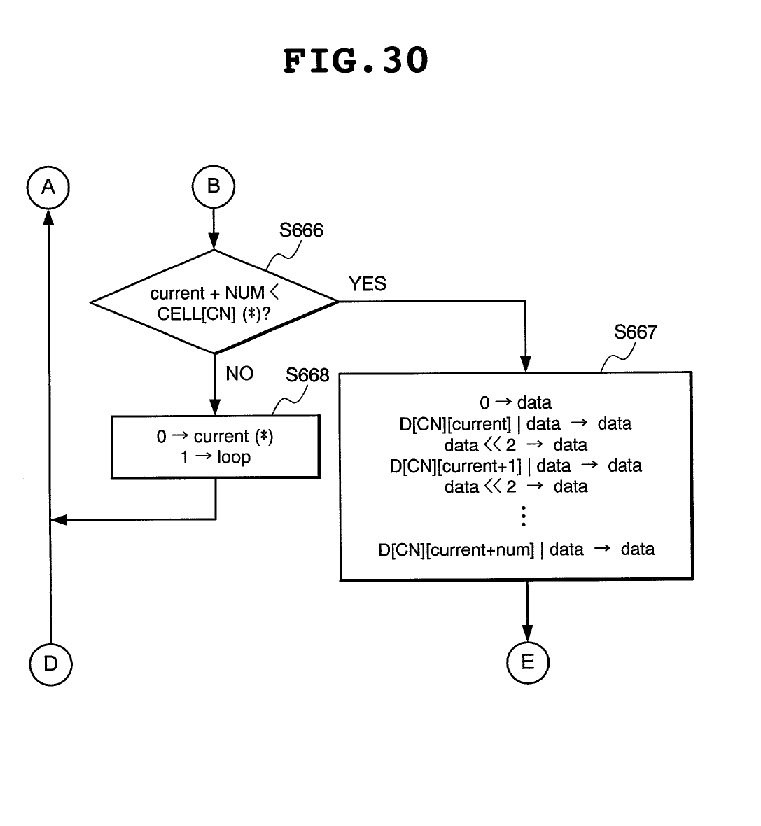

FIGS. 29 to 33 show flows of processing operation for the search and allocation of the third party's memory cell conducted on the CPU side. Of these figures, FIGS. 29 and 30 show flows of processing conducted on the side of the CPU 302 corresponding to the description of FIG. 26. In the processing shown in these figures, as a free memory cell searching direction, only a so-called forward direction indicated by the arrow 362 in FIG. 25 is illustrated. As to the processing conducted in the reverse direction, processing at a place indicated by * in these figures needs a change.

FIG. 29 shows input and output for the processing within a frame 641 and conditions within a frame 642. At step S651, set STRT[CN] as a search starting position at “current” and set “0” indicating that one loop is not yet to be made at a flag value “loop” indicative of existence/non-existence of one loop. Then, at Step S652, determination is made whether “current” is data in the management bit map. When it is not data in the management bit map (N), shift the value of “current” to the head of the management bit map and set “1” as the flag value “loop” indicating that one loop is made (Step S653). Then, return to the processing of Step S652 again.

When the determination is made at Step S652 that it is data in the management bit map (Y), determine whether “1” is set at the flag value indicative of one loop being made (Step S654) and when it is set (Y), determine whether search ends or not (Step S655). If not the search end (N), abnormal end is executed as an error (Step S656). If it is the search end (Y at Step S655), similarly to a case where “1” is not set at the flag value indicative of one loop being made at Step S654 (N), proceed to the following processing shown in FIG. 30.

In FIG. 30, determination is made, when a necessary number of memory cells starting with the memory cell indicated in “current” are allocated as many as the number of memory cells, whether they can be accommodated in the management bit map. If they can be accommodated (Y at Step S666), store a state of the relevant memory cells in data “data” in order to accommodate them in the management bit map (Step S667). When the determination is made at Step S666 that they can not be accommodated (N), conduct the same processing as that described at Step S653 (Step S668) to return to Step S652 of FIG. 29.

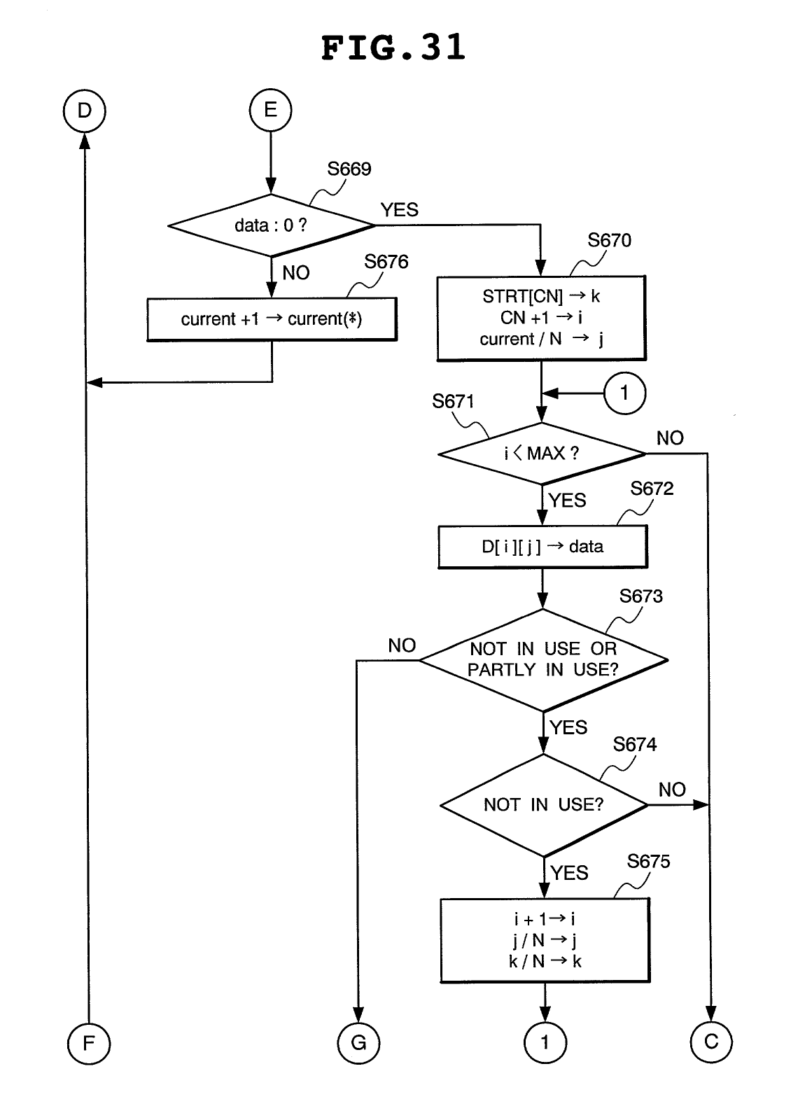

In FIG. 31, on the other hand, check at Step S669 whether all the values of data “data” indicate “not in use”. If so (Y), since “not in use” is indicated in the management bit map “CN”, conduct pre-preparation for determining whether the necessary number “NUM” of memory cells starting with the starting memory cell “current” are really not in use. Determine whether relevant memory cells from the management bit map “CN+1” to the management bit map “MAX” are “not in use” or “partly in use” (Step S670).

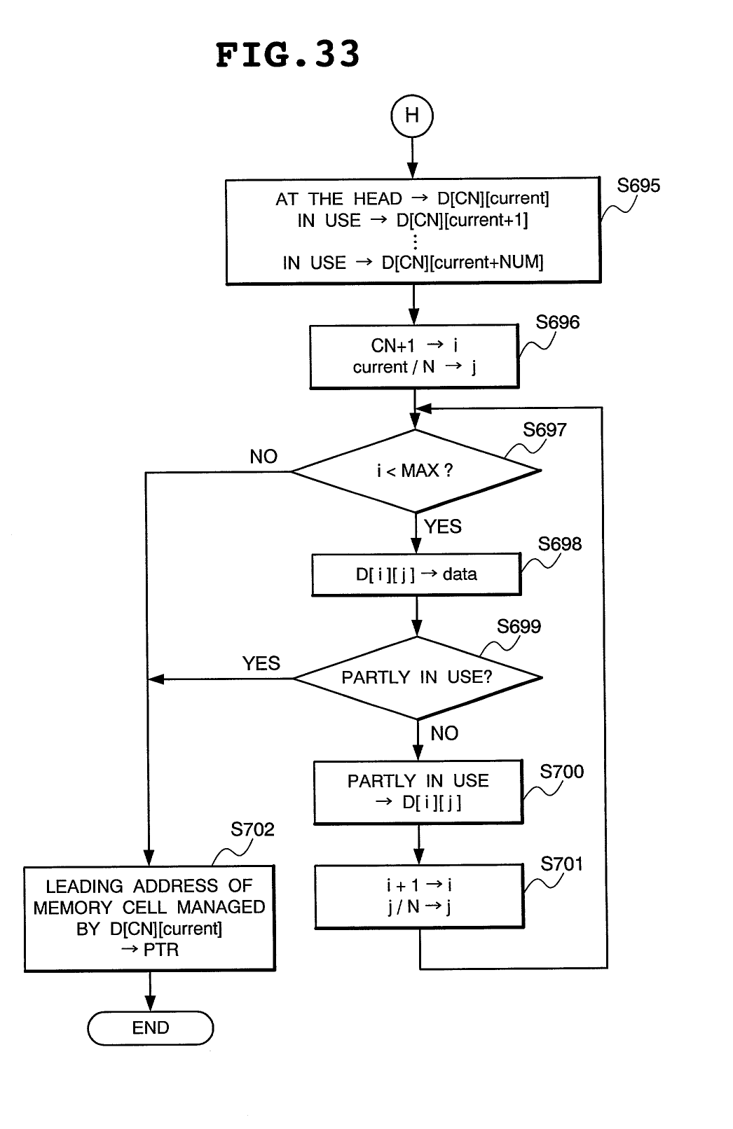

Determine whether such determination is made up to the management bit map “MAX” or not (Step S671) and if the determination is made up thereto (Y), store a state of a memory cell “j” of a management bit map “i” in the data “data” at Step S672. Then, at the subsequent Step S673, determine whether a state of the data “data” corresponds to either “not in use” or “partly in use”. If the state corresponds to either of them, when the state is not in use (Y at Step S674), again determine a state of i+1 (Step S675) to return to the processing of Step S671. On the other hand, when it is the state of partly in use (N at Step S674), proceed to the subsequent processing shown in FIG. 33 because allocation is possible.

On the other hand, when not all the values of data “data” represent “not in use” at Step S669 (N), increment the value of the memory cell “current” by “1” at Step S676 to return to the processing of Step S652 of FIG. 29 (Step S670).

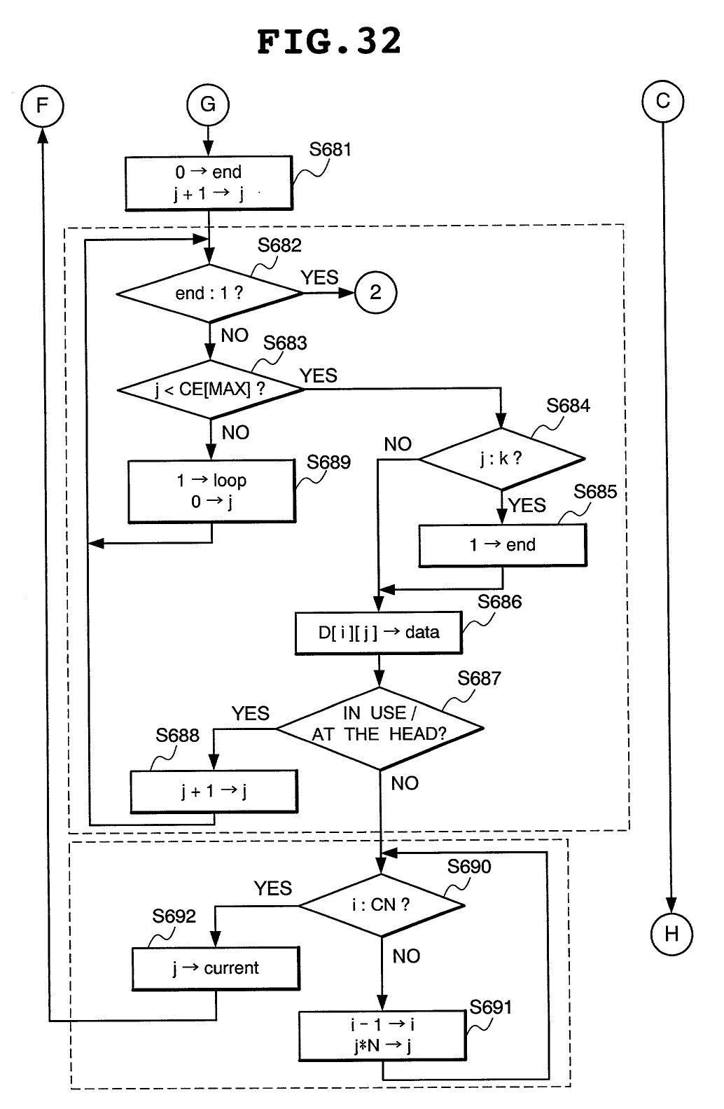

FIG. 32 mainly shows a flow of processing to be conducted when at Step S673 of FIG. 31, determination is made that the state is not “not in use” or “partly in use”. In this processing, first, parameter change is conducted at Step S681. Processing at Steps S682 to S692 is that to be conducted in a case where the determination at Step S673 is made that there exists a memory cell at the state of “in use” or “head of allocation”. At this part, search a memory cell whose state is “not in use” or “partly in use” in the management bit map “i” and when there exists one, convert the relevant memory cell to a memory cell of the management bit map “CN” which manages the same memory region as that of the memory cell in question. Then, return to the processing of Step S652 of FIG. 29.

On the other hand, when the determination is made that there exists no relevant memory cell as a result of search of memory cells, there exists no free memory as in the case of Step S655. Then, in this case, return to Step S656 to have an abnormal end.

FIG. 33 mainly shows a flow of processing to be conducted when negative answers are obtained at Steps S671 and S674 shown in FIG. 31. In this processing, at Step S695, change states of a number “CN” of memory cells starting with “current” into the state of “head of allocation” and “in use”. Then, at Step 696 and the following steps, after the change, change states of the relevant memory cells starting with the management bit map “CN+1” to the management bit map “MAX” into “partly in use”.

Although it is not shown in the foregoing flow charts, a search starting position is also moved after the change of a state of a memory cell. More specifically, (a) change the value of “STRT[CN]” to “current+NUM+1” (*). In addition, (b) determine whether the value of “STRT[CN]” falls within the management bit map. As a result of the determination, when it falls, end the processing. When it fails to fall, make the value of “STRT[CN]” the head of the management bit map (*).

(SECOND PROCESSING OPERATION RELATED TO MEMORY MANAGEMENT)

Next, assume a request for ensuring 30 M-bytes memory is made by a user when the management data region 332 is at the state shown in FIG. 27. In this case, calculate a bit map capable of efficiently managing 30 M-byte data based on the cell size unit 353. The capacity of the second memory cell 341₂ is 8 M-bytes and that of the third memory cell 341₃ is 64 M-bytes. Then, make the second bit map unit 354₂ as a bit map search target. The necessary number of the second memory cells 341₂ in the second memory cell 341₂ will be “4” which is a value obtained by dividing 30 M-bytes by 8 M-bytes and rounding off the remainder.

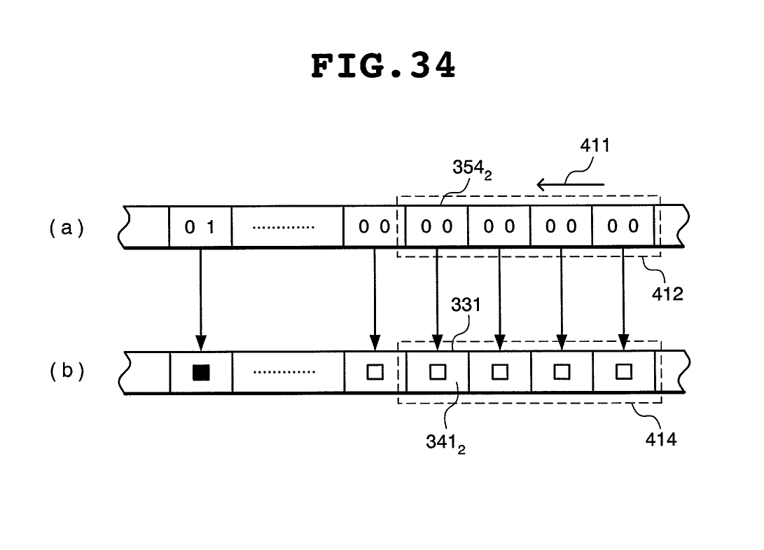

FIG. 34 shows how processing is conducted when a request for ensuring 30 M-byte memory is additionally made. First, sequentially check in the second bit map unit 354₂ shown in FIG. 34(a) whether there exists a bit string indicative of at least four successive second memory cells 341₂ as 30 M-bytes or not. More specifically, check whether in the second bit map unit 354₂, there exists a bit string of eight successive “0”, that is, “00 00 00 00”. This search of successive memory cells not in use is conducted in the direction opposite to the scanning direction in the first bit map unit 354₁ as described previously, so as to scan a frame 412 of four memory cells from the last end of the bit map toward its foremost end as indicated by an arrow 411. At a position of the frame 412 shown in FIG. 34(a), a memory cell not in use which satisfies the condition exists.

FIG. 34(b) shows a memory block 414 composed of the second memory cells 341₂ corresponding to the second bit map unit 354₂ in the memory region 331.

When determination is thus made that at the position of the frame 412 shown in the figure at the second bit map unit 354₂, a bit string indicative of four memory cells not in use exists, check at the following processing whether the four second memory cells 341₂ constituting the memory block 414 are really not in use.

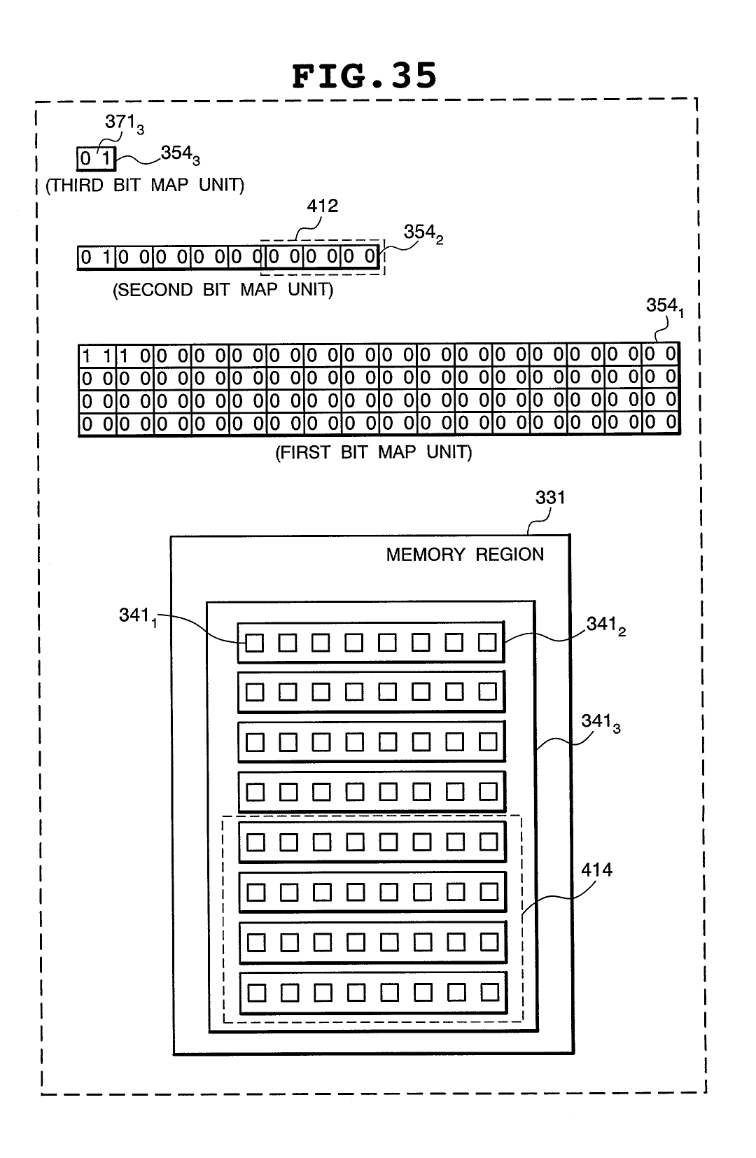

FIG. 35 shows the principle of processing of checking whether each memory cell is not in use based on determination results of the bit map unit. Similarly to FIG. 26, the figure shows the first to third bit map units 354₁ to 354₃ and the first to third memory cells 341₁ to 341₃ in the memory region 331 in comparison. As is already described, the bit string storing a state of the third memory cell 341₃ at the third bit map unit 354₃ is denoted as the third bit string 371₃. In this case, the four second memory cells 341₂ constituting the memory block 414 are not in use in either of the following two cases:

(1) where the third bit string 371₃ is “00” indicative of the state of not in use;

(2) where the third bit string 371₃ is “01” indicative of the state of partly in use.

Assume that by the foregoing check, determination is made that the memory block 414 is not in use. In this case, memory management is conducted so as to change the current state of the relevant memory block 414 to “in use”. In order thereto, as shown in FIG. 34, change a bit string in the frame 412 at the bit map corresponding to the memory block 414 to “11” which is a bit string indicative of the head of a block used and “01” indicative of a block used. The third bit string 371₃ shown in FIG. 35 also should be changed to the bit string “01” indicative of being in use. In this example, however, when 2 M-byte memory is ensured in the previous first processing operation, it is already changed to the bit string “01”. Therefore, the third bit string 371₃ as a bit string storing the state of the third memory cell 341₃ remains the same state to have no change.

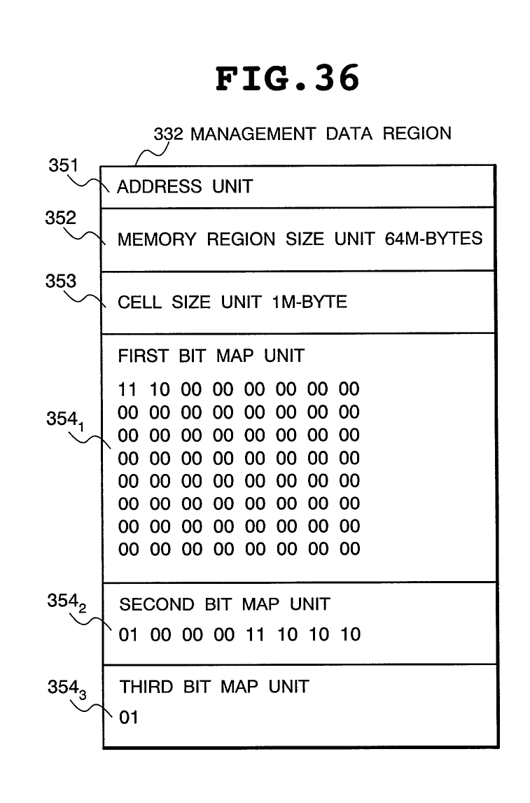

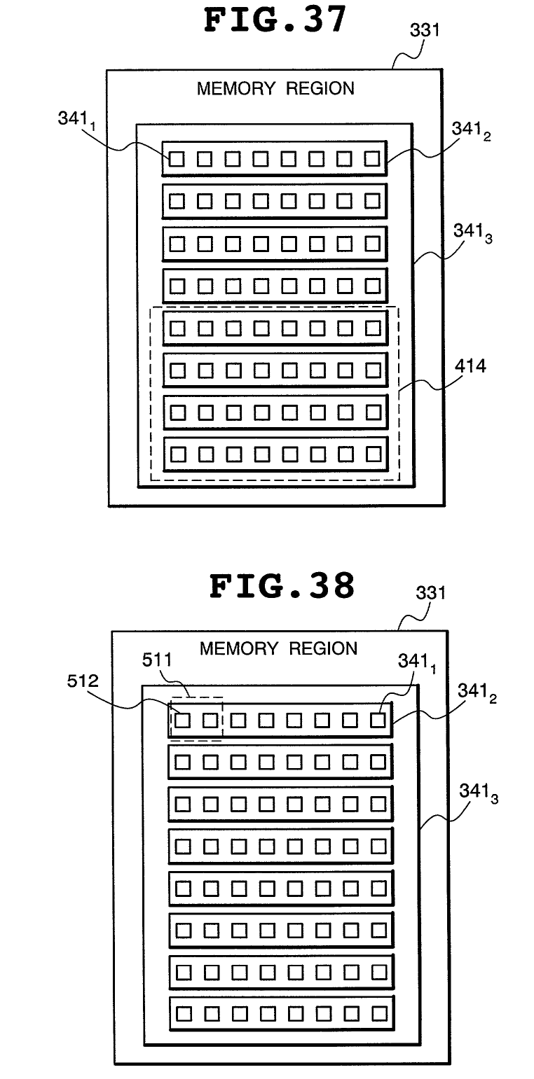

FIG. 36 shows a state of change of the management data region at a time when the foregoing first processing operation is completed, while FIG. 37 shows a state of the memory region in which memory is ensured according to the change. These correspond to FIGS. 27 and 28 for use in explaining the first processing operation related to the memory management. In the second bit map unit 354₂ of the management data region 332 shown in FIG. 36, the bit string corresponding to the memory block 414 shown in FIG. 37 is changed to “11 10 10 10” as mentioned above. The bit string of the third bit map unit 354₃ remains “01” as described above. By transferring thus ensured memory block 363 to a user to respond to the request for ensuring 30 M-byte memory and by changing a bit string corresponding to the relevant second memory cell 341₂ in the bit map to the state of the head of a block used and the state of in use, allocation of the second memory cell 341₂ is realized.

(THIRD PROCESSING OPERATION RELATED TO MEMORY MANAGEMENT)

Description will be next made of a case where when the management data region 332 is at the state shown in FIG. 36, a user requests release of a part of the memory region.

FIG. 38 shows a position of a memory block whose release is requested by the user in this case. Upon such a request, check is conducted to see if among relevant bit strings in the first to third bit map units 354₁ to 354₃ corresponding to an address 512 that a predetermined memory block 511 of the memory region 331 indicates, there exists a bit string indicative of the head of a block used.

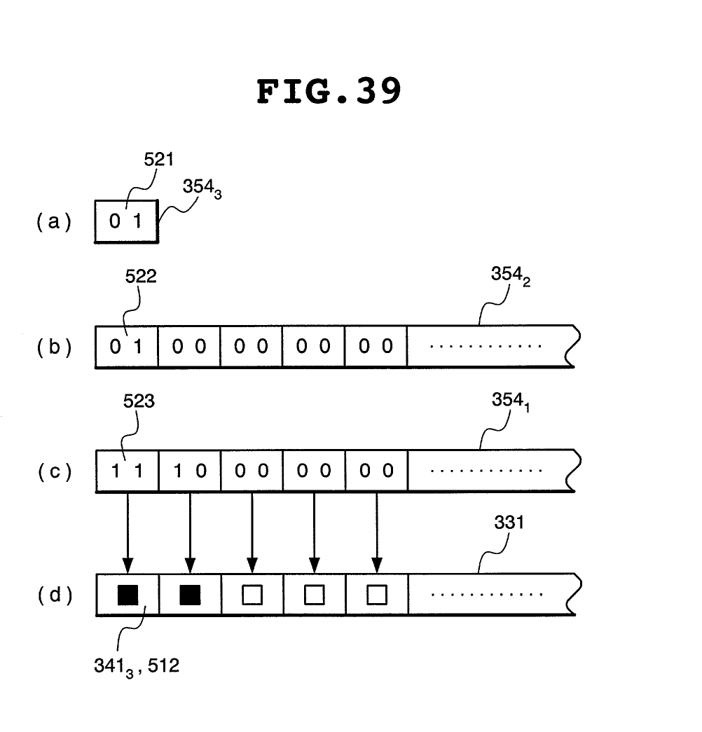

FIG. 39 is a diagram for use in explaining how existence of a bit string indicative of the head of a block used is checked. FIG. 39(a) shows a bit string 521 of the third bit map unit 354₃. In this embodiment, the third bit map unit 354₃ has only one bit string 521 composed of two bits. The bit string 521 therefore forms the leading bit string. FIG. 39(b) shows the second bit map unit 354₂ in which a bit string at the left end forms a bit string 522 located at the head. FIG. 39(c) shows the third bit map unit 354₃ in which a bit string at the left end similarly forms a bit string 523 located at the head.

Checking whether there exists a bit string indicative of the head of the block used among the bit strings 521 to 523 is searching a bit string having “11”.

In the example shown in FIG. 39, the bit string 523 in the first bit map unit 354₁ has “11” to satisfy the condition. Therefore, a bit map managing the memory block 511 shown in FIG. 38 as the head of the block used and the block used, and a leading memory cell are found.

When the bit string 523 indicative of the head of the block used is thus found among the bit strings 521 to 523, set the first memory cell 341₁ at the address 512 corresponding to the leading bit string 523 at the state of not in use. Then, set all the first memory cells 341₁ successively allocated starting at the leading first memory cell 341₁ to be at the state of not in use.

In other words, as long as bit strings following “11” as the bit string 523 located at the head in FIG. 39(c) have “10” indicative of a block in use, change all these into “00” which is a bit string indicative of the state of not in use. Thus, until other 2-digit bit string appears than the bit string “10”, release all these as one memory block.

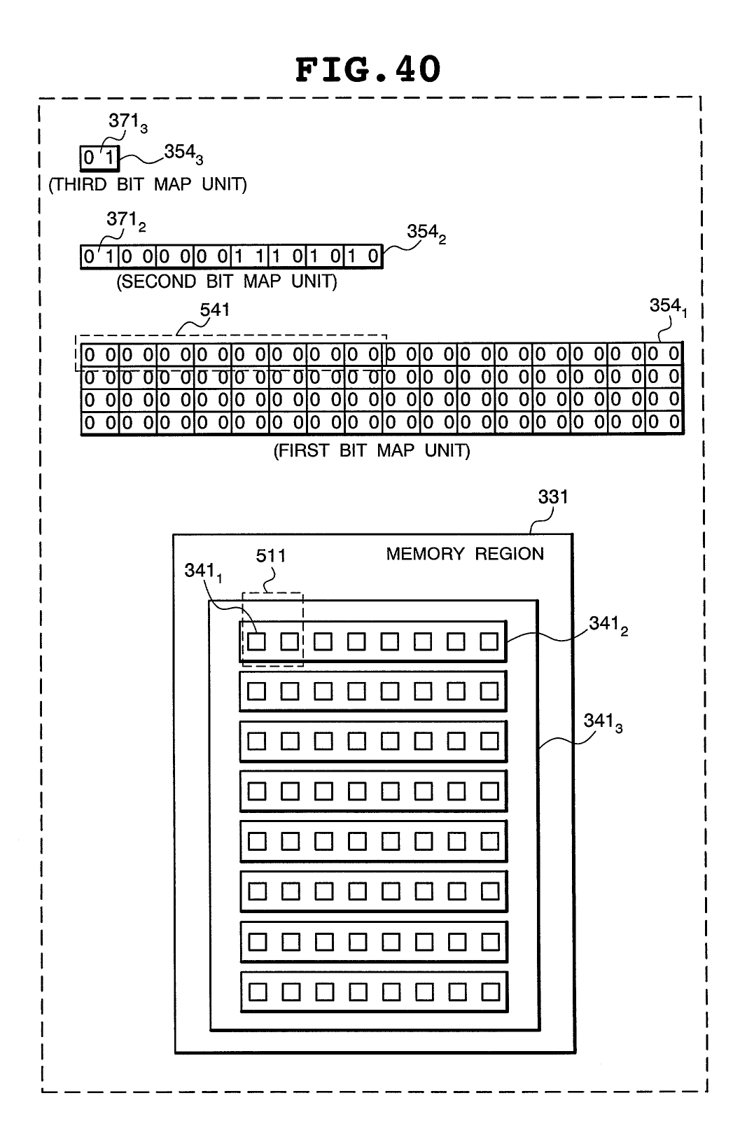

FIG. 40 is a diagram for use in explaining processing conducted after the first memory cell is thus set to be not in use. When the memory block 511 in the memory region 331 requested by the user is released, at the relevant bit map unit (the first bit map unit 354₁ in this case), checking is conducted to see if states of a number N (eight in the present embodiment) of memory cells which are all the first memory cells 341₁ including the memory block 511 are not in use.

More specifically, examine whether in the first bit map unit 354₁, a bit string 541 storing the state of the first memory cell 341₁ is “00 00 00 00 00 00 00 00”. If so, the bit string 541 all indicates the state of not in use.

In this case, change the state of the relevant memory cell in the second bit map unit 354₂ storing the state of the second memory cell 341₂ to the bit string “00” indicative of the state of not in use. The same change is made also of a state of a memory cell managing the same memory region as that of the third memory cell 3413. In this embodiment, however, since not all the bit strings assume the state of not in use, at this state, the state of the third bit map unit 354₃ corresponding to the third memory cell 341₃ will not have a bit string “00” but remains “01”.

As described in the foregoing, release of memory is realized by changing a state of a bit map unit of a relevant memory cell to be not in use.

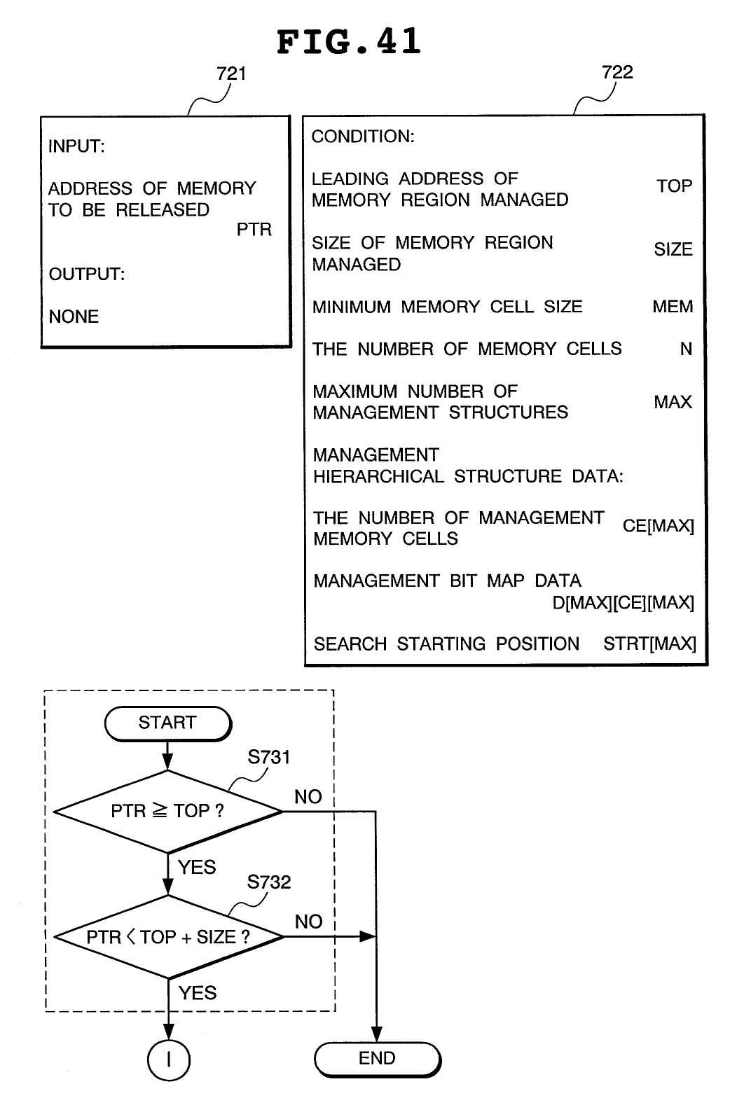

FIG. 41 shows input and output for processing within a frame 721 and conditions within a frame 722. At Step S731, find whether an address “PTR” of memory to be released is not less than the leading address “TOP” of the managed memory region and when it is more than the leading address “TOP” (Y), check whether the address “PTR” of the memory to be released is not more than a value obtained by adding the leading address “TOP” of the managed memory region and the managed memory region size “SIZE” (Step S732). When it is smaller than the value obtained by the addition of the two (Y), proceed to the subsequent processing. When other determination is made at Steps S731 and S732 (N), which means that an address outside the memory region is designated, end the processing without doing anything (end).

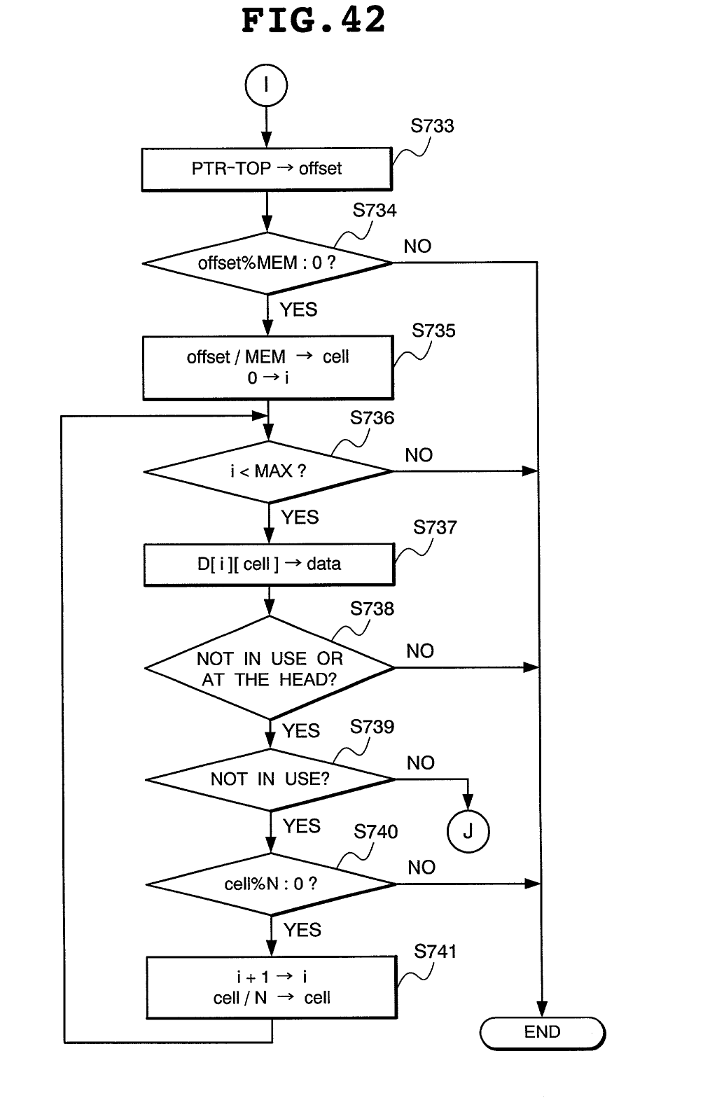

FIG. 42 illustrates a series of the processing shown at Step S732 of FIG. 41. First at Step S733, obtain an offset “offset” of an input address in the memory. Check whether the offset “offset” can be divided by the size “MEM” of the minimum memory cell or not (Step S734). When it can not be divided (N), end the processing as it is because of error (end).

When it can be divided (Y at Step S734), convert the input address (memory) into a memory cell of a management bit map generated with the smallest memory cell size. Then, set the variable “i” at “0” (Step S735) to check whether it is less than the largest number of management structures “MAX” (Step S736). When it is not less than the number (N), end the processing (end).

In other cases than that mentioned above (Y at Step S736), store the state of the relevant memory cell in data “data” (Step S737). Check whether the state of the memory cell is at the state of “not in use” or “head of allocation” (S738) and when it is neither of them (N), end the processing as it is (end). When it is at the state of “not in use” (Y at Step S739), determine whether the relevant memory cell has the same address as that of a memory cell which manages the same memory as the relevant memory cell does (Step S740). When the address is not the same (N), end the processing as it is (end).

On the other hand, when the address is the same as that of a memory cell managing the same memory as that managed by the relevant memory cell (Y at Step 740), move to a memory cell of a bit map managing the same memory as that managed by the relevant memory cell (Step S741). Then, processing returns to Step S736.

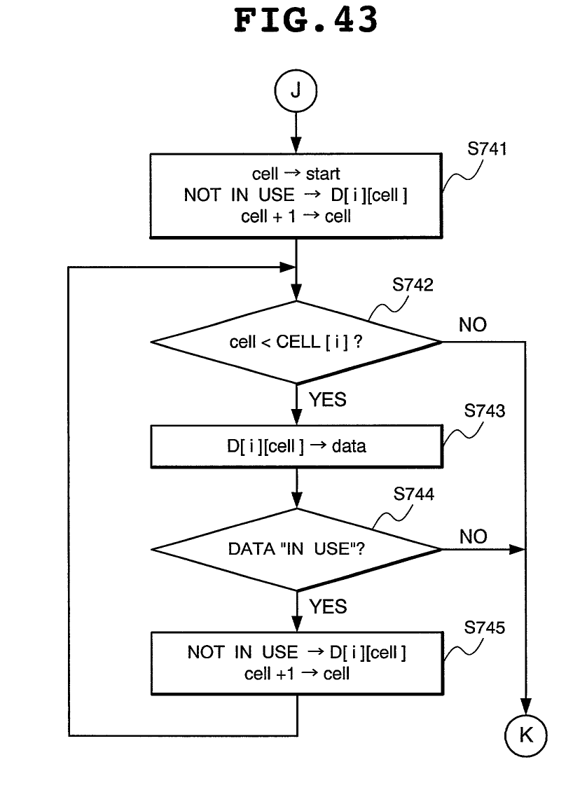

FIG. 43 shows processing to be conducted after the determination of the state of “head of allocation” is made at Step S739. In this case (N), change the state of the relevant memory cell to “not in use”. Then, store the state of a memory cell subsequent to the memory cell whose state has been changed to “not in use” in the data “data” (Steps S742 and S743). Determine whether the stored data “data” is “in use” or not (Step S744) and when it is “in use” (Y), change the state of the relevant memory cell to “not in use” (Step S745).

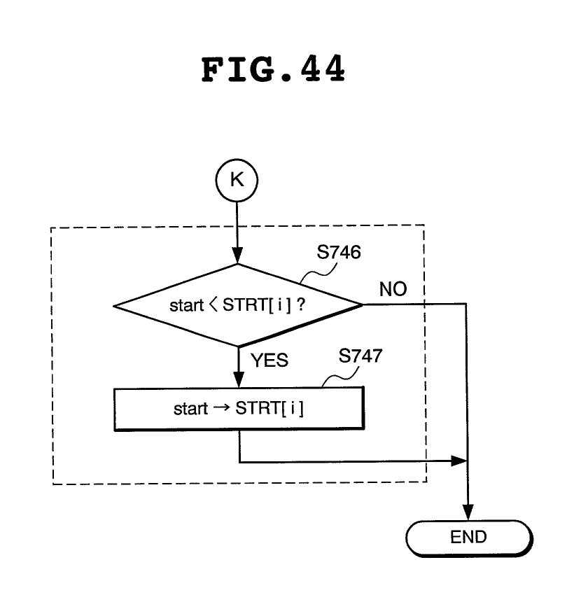

FIG. 44 shows a flow of processing to be conducted when the determination of negation (N) is made at Steps S742 and S735 of FIG. 43. At Step S746, determination is made whether the memory cell whose state has been changed to “not in use” is located before the current search starting position and when it is so (Y), move the search starting position to the memory cell released this time (Step S474). When it is not located before, end the processing as it is (end).

As described in the foregoing, since according to the present invention, memory cells have a hierarchical structure, it is possible in response to a request for memory of various sizes to switch and search a bit map unit for ensuring a necessary region. Accordingly, processing of ensuring and releasing memory can be conducted at a high speed irrespective of a size of a requested memory region. In addition, since a plurality of sizes are set for memory cells, segregative use of regions ensured according to these sizes is possible, which makes division of successive memory not in use in a memory region hard.

In addition to obtaining the same effect as mentioned above, since a memory cell use state at a bit map unit is represented as at least three states, “not in use” indicative of a state where a memory cell is not in use, “partly in use” indicative of a state where a part of it is used and “in use” indicative of a state where all of it is in use, the present invention is allowed to narrow down targets of search at the time of ensuring and releasing memory according to characteristics of these states, thereby enabling increase in a search speed.

Moreover, since a memory cell use state at a bit map unit is represented as four states, “not in use” indicative of a state where a memory cell is not in use, “partly in use” indicative of a state where a part of it is used, “in use” indicative of a state where all of it is in use, and “head of allocation” indicative of a leading memory cell in which data of a requested memory size is stored, the present invention is allowed to narrow down targets of search at the time of ensuring and releasing memory according to characteristics of these states by the use of only two-bit information, thereby enabling increase in a search speed. In addition, addition of the state having a concept of “head of allocation” facilitates finding on which memory cell the head of a region to which memory is allocated falls.

Also according to the present invention, when there exists a memory cell whose size is relatively approximate to and larger than a requested memory size, not by ensuring memory satisfying the request by collecting as many lower-order memory cells in size as the number constituting a higher-order memory cell resultantly but by ensuring one higher-order memory cell, simplification of memory management can be achieved.

Moreover, according to the present invention, since with respect to a requested memory size, not by using one or a plurality of one kind of memory cells approximate to and smaller than the size to satisfy the requirement but by combining various kinds of memory cells to cope with the requested memory size, efficient memory management can be attained all the time.

Furthermore, since according to the present invention, a memory region is divided into two to either of which a memory cell of each size is allocated, segregative use of data according to a requested amount of memory is facilitated to make a possibility of generation of fragments at the memory region lower.

In addition, the same effects as those of the inventions mentioned above can be obtained and also efficient memory management is possible because with a readable and writable memory region of a predetermined size divided into two at a predetermined address as boundaries to have a first memory region and a second memory region to which a memory cell of each layer is to be allocated, at a request for ensuring memory in the memory region is made, the present invention is designed to select a combination of memory cells satisfying the requested memory size between a memory cell of a size smaller than and most approximate to the requested memory size and a memory cell of a size further smaller than the former memory cell.

Moreover, according to the present invention, since an address searching means of the memory management device is designed to have search directions in layers in which memory sizes are adjacent set to have the address search directions opposite to each other, segregative use of memory in each layer can be attained to make generation of fragments less liable to occur in the memory region.

Also, according to the present invention, because the memory management device is provided with an adjacent memory cell determination means for determining, when there is a continuous free region at a place where two memory cells are adjacent to each other at least one of which is at the state of “partly in use”, whether the continuous free region has a size larger than a size of memory requested at the time when a request for ensuring memory is made, when the request is satisfied, such a region can be ensured to enable successively ensuring a memory region quickly.

Furthermore, since according to the present invention, the memory management device is designed to select, at the time of releasing memory, a memory cell whose size is smaller than and most approximate to the size of the memory to be released and search the corresponding bit map for a relevant memory cell, processing speed at the time of release can be increased.

In addition, since according to the present invention, the memory management device searches for a leading address of memory to be released from among memory cells at the state of “head of allocation”, search processing speed will be further increased.

Moreover, the present invention enables a change of a memory cell use state at the time of release to be reliably reflected on a state of each memory cell.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

What is claimed is:

1. A memory management device comprising:
memory region size storing means for storing a size of a predetermined-size readable and writable memory region,
first memory size storing means for storing a size of a fixed-length block as a first memory cell which divides a memory region of a size stored in the memory region size storing means,
a first bit map unit for storing a state of use of each said first memory cell in said memory region as a bit map,
second to a-th bit map units for, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map,
memory cell layer selecting means for, upon a request for ensuring memory in said memory region, selecting a layer of a memory cell whose size is smaller than and most approximate to the requested memory size,
address searching means for searching a bit map unit corresponding to a memory cell of a layer selected by the memory cell layer selecting means for an address indicative of a place at which the minimum number of successive memory cells exist necessary for satisfying the size of said memory requested to be ensured, and
memory ensuring means for ensuring said memory region equivalent to the minimum number of successive memory cells necessary for satisfying the size of said memory requested to be ensured by using an address searched by the address searching means.

2. The memory management device as set forth in claim 1, wherein
said address searching means has a search direction set to have address search directions be opposite to each other in layers in which memory sizes are adjacent.

3. The memory management device as set forth in claim 1, further comprising:
release-time memory cell selecting means for, upon a request for releasing memory ensured in said memory region, selecting a memory cell whose size is smaller than and most approximate to a size of the memory to be released,
release-time searching means for searching a bit map indicative of a state of a memory cell selected by the release-time memory cell selecting means for a memory cell to be released, and
memory releasing means for releasing a relevant data region of a memory cell searched by the releasetime searching means.

4. A memory management device comprising:
memory region size storing means for storing a size of a predetermined-size readable and writable memory region,
first memory size storing means for storing a size of a fixed-length block as a first memory cell which divides a memory region of a size stored in the memory region size storing means,
a first bit map unit for storing a state of use of each said first memory cell in said memory region as a bit map indicative any of at least three states of “not in use” indicating a state where a memory cell is not in use, “partly in use” indicating a state where a memory cell is partly in use and “in use” indicating a state where all the memory cell is in use,
second to a-th bit map units for, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map indicative any of at least three states of “not in use” indicating a state where a memory cell is not in use, “partly in use” indicating a state where a memory cell is partly in use and “in use” indicating a state where all the memory cell is in use,
memory cell layer selecting means for, upon a request for ensuring memory in said memory region, selecting a layer of a memory cell whose size is smaller than and most approximate to the requested memory size,
address searching means for searching a bit map unit corresponding to a memory cell of a layer selected by the memory cell layer selecting means for an address indicative of a place at which one or a plurality of successive memory cells exist where data equivalent to the size of said memory requested to be ensured can be successively stored, with a memory cell at said state of “not in use” or “partly in use” as a leading address,
memory ensuring means for ensuring said memory region equivalent to the minimum number of successive memory cells necessary for satisfying the size of said memory requested to be ensured by using an address searched by the address searching means, and
bit map unit changing means for changing states of a bit map corresponding to a memory cell ensured by the memory ensuring means and a bit map corresponding to a memory cell whose layer is higher than the layer of the ensured memory cell and whose state is subjected to a change into “partly in use” or “in use” according to the state obtained after the change.

5. The memory management device as set forth in claim 4, wherein
said address searching means has a search direction set to have address search directions be opposite to each other in layers in which memory sizes are adjacent.

6. The memory management device as set forth in claim 4, further comprising
adjacent memory cell determining means for, when successive free regions exist at a place where two memory cells are adjacent to each other at least one of which is at the state of “partly in use”, determining whether the successive free regions are larger than the size of said requested memory at the time when the request for ensuring said memory is made.

7. The memory management device as set forth in claim 4, further comprising:
release-time memory cell selecting means for, upon a request for releasing memory ensured in said memory region, selecting a memory cell whose size is smaller than and most approximate to a size of the memory to be released,
release-time searching means for searching a bit map indicative of a state of a memory cell selected by the release-time memory cell selecting means for a memory cell to be released, and
memory releasing means for releasing a relevant data region of a memory cell searched by the releasetime searching means.

8. A memory management device comprising:
memory region size storing means for storing a size of a predetermined-size readable and writable memory region,
first memory size storing means for storing a size of a fixed-length block as a first memory cell which divides a memory region of a size stored in the memory region size storing means,
a first bit map unit for storing a state of use of each said first memory cell in said memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
second to a-th bit map units for, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
memory cell layer selecting means for, upon a request for ensuring memory in said memory region, selecting a layer of a memory cell whose size is smaller than and most approximate to the requested memory size,
address searching means for searching a bit map unit corresponding to a memory cell of a layer selected by the memory cell layer selecting means for an address indicative of a place at which one or a plurality of successive memory cells exist where data equivalent to the size of said memory requested to be ensured can be successively stored, with a memory cell at said state of “not in use” or “partly in use” as a leading address,
memory ensuring means for ensuring said memory region equivalent to the minimum number of successive memory cells necessary for satisfying the size of said memory requested to be ensured by using an address searched by the address searching means, and
bit map unit changing means for changing a bit map corresponding to a memory cell ensured by the memory ensuring means into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

9. The memory management device as set forth in claim 8, wherein
said address searching means has a search direction set to have address search directions be opposite to each other in layers in which memory sizes are adjacent.

10. The memory management device as set forth in claim 8, further comprising
adjacent memory cell determining means for, when successive free regions exist at a place where two memory cells are adjacent to each other at least one of which is at the state of “partly in use”, determining whether the successive free regions are larger than the size of said requested memory at the time when the request for ensuring said memory is made.

11. The memory management device as set forth in claim 8, further comprising:
release-time memory cell selecting means for, upon a request for releasing memory ensured in said memory region, selecting a memory cell whose size is smaller than and most approximate to a size of the memory to be released,
release-time searching means for searching a bit map indicative of a state of a memory cell selected by the release-time memory cell selecting means for a memory cell to be released, and
memory releasing means for releasing a relevant data region of a memory cell searched by the release-time searching means.

12. The memory management device as set forth in claim 8, wherein
a leading address of memory to be released is searched for from among memory cells at the state of “head of allocation”.

13. A memory management device comprising:
memory region size storing means for storing a size of a predetermined-size readable and writable memory region,
first memory size storing means for storing a size of a fixed-length block as a first memory cell which divides a memory region of a size stored in the memory region size storing means,
a first bit map unit for storing a state of use of each said first memory cell in said memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
second to a-th bit map units for, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
one-order higher layer memory cell selecting means for, upon a request for ensuring memory in said memory region, determining whether there exists a memory cell whose size is relatively close to and larger than the requested memory size,
first memory cell layer selecting means for, when the one-order higher layer memory cell selecting mean determines that there exists no memory cell satisfying the condition, selecting a layer of a memory cell whose size is smaller and most approximate to the requested memory size,
second memory cell layer selecting means for, when said one-order higher layer memory cell selecting mean determines that there exists a memory cell satisfying the condition, selecting the memory cell of the layer,
address searching means for searching a bit map unit corresponding to a memory cell of a layer selected by said first or second memory cell layer selecting means for an address indicative of a place at which one or a plurality of successive memory cells exist where data equivalent to the size of said memory requested to be ensured can be successively stored, with a memory cell at said state of “not in use” or “partly in use” as a leading address,
memory ensuring means for ensuring said memory region equivalent to the minimum number of successive memory cells necessary for satisfying the size of said memory requested to be ensured by using an address searched by the address searching means, and
bit map unit changing means for changing a bit map corresponding to a memory cell ensured by the memory ensuring means into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

14. The memory management device as set forth in claim 13, wherein
said address searching means has a search direction set to have address search directions be opposite to each other in layers in which memory sizes are adjacent.

15. The memory management device as set forth in claim 13, further comprising
adjacent memory cell determining means for, when successive free regions exist at a place where two memory cells are adjacent to each other at least one of which is at the state of “partly in use”, determining whether the successive free regions are larger than the size of said requested memory at the time when the request for ensuring said memory is made.

16. The memory management device as set forth in claim 13, further comprising:
release-time memory cell selecting means for, upon a request for releasing memory ensured in said memory region, selecting a memory cell whose size is smaller than and most approximate to a size of the memory to be released,
release-time searching means for searching a bit map indicative of a state of a memory cell selected by the release-time memory cell selecting means for a memory cell to be released, and
memory releasing means for releasing a relevant data region of a memory cell searched by the release-time searching means.

17. The memory management device as set forth in claim 13, wherein
a leading address of memory to be released is searched for from among memory cells at the state of “head of allocation”.

18. A memory management device comprising:
memory region size storing means for storing a size of a predetermined-size readable and writable memory region,
first memory size storing means for storing a size of a fixed-length block as a first memory cell which divides a memory region of a size stored in the memory region size storing means,
a first bit map unit for storing a state of use of each said first memory cell in said memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
second to a-th bit map units for, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
memory cell selecting means for, upon a request for ensuring memory in said memory region, selecting a combination of memory cells satisfying said requested memory size by combining a memory cell whose size is smaller than and most approximate to the requested memory size and a memory cell of a further smaller size,
address searching means for searching a bit map unit corresponding to a memory cell of each layer selected by the memory cell selecting means for an address indicative of a place at which one or a plurality of successive memory cells exist where data equivalent to the size of said memory requested to be ensured can be successively stored, with a memory cell at said state of “not in use” or “partly in use” as a leading address,
memory ensuring means for ensuring said memory region equivalent to the minimum number of successive memory cells necessary for satisfying the size of said memory requested to be ensured by using an address searched by the address searching means, and
bit map unit changing means for changing a bit map corresponding to a memory cell ensured by the memory ensuring means into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

19. The memory management device as set forth in claim 18, wherein
said address searching means has a search direction set to have address search directions be opposite to each other in layers in which memory sizes are adjacent.

20. The memory management device as set forth in claim 18, further comprising
adjacent memory cell determining means for, when successive free regions exist at a place where two memory cells are adjacent to each other at least one of which is at the state of “partly in use”, determining whether the successive free regions are larger than the size of said requested memory at the time when the request for ensuring said memory is made.

21. The memory management device as set forth in claim 18, further comprising:
release-time memory cell selecting means for, upon a request for releasing memory ensured in said memory region, selecting a memory cell whose size is smaller than and most approximate to a size of the memory to be released,
release-time searching means for searching a bit map indicative of a state of a memory cell selected by the release-time memory cell selecting means for a memory cell to be released, and
memory releasing means for releasing a relevant data region of a memory cell searched by the release-time searching means.

22. The memory management device as set forth in claim 18, wherein
a leading address of memory to be released is searched for from among memory cells at the state of “head of allocation”.

23. A memory management device comprising:
memory region size storing means for storing a size of a predetermined-size readable and writable memory region,
first memory size storing means for storing a size of a fixed-length block as a first memory cell which divides a first memory region obtained by dividing a memory region of a size stored in the memory region size storing means in half at a predetermined address as a boundary,
a first bit map unit for storing a state of use of each said first memory cell in said first memory region as a bit map indicative any of four states of “not in use” indicating a state where a memory cell is not in use, “partly in use” indicating a state where a memory cell is partly in use, “in use” indicating a state where all the memory cells is in use, and “head of allocation” indicating the head of a memory cell where data of a requested memory size is stored,
second to a-th bit map units for, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, allocating these memory cells to said first memory region and a remaining second memory region and storing a state of use of each memory cell corresponding to the first and the second memory regions as a bit map,
memory cell layer selecting means for, upon a request for ensuring memory in said memory region, selecting a layer of a memory cell whose size is smaller than and most approximate to the requested memory size,
address searching means for searching a bit map unit corresponding to a memory cell of a layer selected by the memory cell layer selecting means for an address indicative of a place at which the minimum number of successive memory cells exist necessary for satisfying the size of said memory requested to be ensured, and
memory ensuring means for ensuring said memory region equivalent to the minimum number of successive memory cells necessary for satisfying the size of said memory requested to be ensured by using an address searched by the address searching means.

24. The memory management device as set forth in claim 23, wherein
said address searching means has a search direction set to have address search directions be opposite to each other in layers in which memory sizes are adjacent.

25. The memory management device as set forth in claim 23, further comprising
adjacent memory cell determining means for, when successive free regions exist at a place where two memory cells are adjacent to each other at least one of which is at the state of “partly in use”, determining whether the successive free regions are larger than the size of said requested memory at the time when the request for ensuring said memory is made.

26. The memory management device as set forth in claim 23, further comprising:
release-time memory cell selecting means for, upon a request for releasing memory ensured in said memory region, selecting a memory cell whose size is smaller than and most approximate to a size of the memory to be released,
release-time searching means for searching a bit map indicative of a state of a memory cell selected by the release-time memory cell selecting means for a memory cell to be released, and
memory releasing means for releasing a relevant data region of a memory cell searched by the release-time searching means.

27. The memory management device as set forth in claim 23, wherein
a leading address of memory to be released is searched for from among memory cells at the state of “head of allocation”.

28. A memory management device comprising:
memory region size storing means for storing a size of a predetermined-size readable and writable memory region,
first memory size storing means for storing a size of a fixed-length block as a first memory cell which divides a first memory region obtained by dividing a memory region of a size stored in the memory region size storing means in half at a predetermined address as a boundary,
a first bit map unit for storing a state of use of each said first memory cell in said first memory region as a bit map,
second to a-th bit map units for, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, representing a state of use of each memory cell as any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored, allocating these memory cells to said first memory region and a remaining second memory region and storing a state of use of each memory cell corresponding to the first and the second memory regions as a bit map,
memory cell selecting means for, upon a request for ensuring memory in said memory region, selecting a combination of memory cells satisfying said requested memory size by combining a memory cell whose size is smaller than and most approximate to the requested memory size and a memory cell of a further smaller size,
address searching means for searching a bit map unit corresponding to a memory cell of each layer selected by the memory cell selecting means for an address indicative of a place at which one or a plurality of successive memory cells exist where data equivalent to the size of said memory requested to be ensured can be successively stored, with a memory cell at said state of “not in use” or “partly in use” as a leading address,
memory ensuring means for ensuring said memory region equivalent to the minimum number of successive memory cells necessary for satisfying the size of said memory requested to be ensured by using an address searched by the address searching means, and
bit map unit changing means for changing a bit map corresponding to a memory cell ensured by the memory ensuring means into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

29. The memory management device as set forth in claim 28, wherein
said address searching means has a search direction set to have address search directions be opposite to each other in layers in which memory sizes are adjacent.

30. The memory management device as set forth in claim 28, further comprising
adjacent memory cell determining means for, when successive free regions exist at a place where two memory cells are adjacent to each other at least one of which is at the state of “partly in use”, determining whether the successive free regions are larger than the size of said requested memory at the time when the request for ensuring said memory is made.

31. The memory management device as set forth in claim 28, further comprising:
release-time memory cell selecting means for, upon a request for releasing memory ensured in said memory region, selecting a memory cell whose size is smaller than and most approximate to a size of the memory to be released,
release-time searching means for searching a bit map indicative of a state of a memory cell selected by the release-time memory cell selecting means for a memory cell to be released, and
memory releasing means for releasing a relevant data region of a memory cell searched by the releasetime searching means.

32. The memory management device as set forth in claim 28, wherein
a leading address of memory to be released is searched for from among memory cells at the state of “head of allocation”.

33. The memory management device as set forth in claim 31, further comprising
release-time bit map changing means for, when said memory releasing means releases memory from said memory region, changing a memory cell selected by said release-time memory cell selecting means into the state of “not in use” or “partly in use” depending on the state of the memory cell, and changing, to the state of “not in use”, a bit map corresponding to the selected memory cell and among higher-order bit maps covering the bit map, a bit map in which no other relevant memory cell is in use and changing a bit map in which relevant memory cells are changed to the state of partly in use into the state of “partly in use”.

34. A memory management method comprising:
a memory region size storing step of storing a size of a predetermined-size readable and writable memory region,
a first memory size storing step of storing a size of a fixed-length block as a first memory cell which divides a memory region of a size stored at the memory region size storing step,
a first bit map unit storing step of storing a state of use of each said first memory cell in said memory region as a bit map,
a second to a-th bit map unit storing step of, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map,
a memory cell layer selecting step of, upon a request for ensuring memory in said memory region, selecting a layer of a memory cell whose size is smaller than and most approximate to the requested memory size,
an address searching step of searching a bit map unit corresponding to a memory cell of a layer selected by the memory cell layer selecting step for an address indicative of a place at which the minimum number of successive memory cells exist necessary for satisfying the size of said memory requested to be ensured, and
a memory ensuring step of ensuring said memory region equivalent to the minimum number of successive memory cells necessary for satisfying the size of said memory requested to be ensured by using an address searched by the address searching step.

35. A memory management method comprising:
a memory region size storing step for storing a size of a predetermined-size readable and writable memory region,
a first memory size storing step of storing a size of a fixed-length block as a first memory cell which divides a memory region of a size stored at the memory region size storing step,
a first bit map unit storing step of storing a state of use of each said first memory cell in said memory region as a bit map indicative any of at least three states of “not in use” indicating a state where a memory cell is not in use, “partly in use” indicating a state where a memory cell is partly in use and “in use” indicating a state where all the memory cell is in use,
a second to a-th bit map unit storing step of, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map indicative any of at least three states of “not in use” indicating a state where a memory cell is not in use, “partly in use” indicating a state where a memory cell is partly in use and “in use” indicating a state where all the memory cell is in use,
a memory cell layer selecting step of, upon a request for ensuring memory in said memory region, selecting a layer of a memory cell whose size is smaller than and most approximate to the requested memory size,
an address searching step of searching a bit map unit corresponding to a memory cell of a layer selected by the memory cell layer selecting step for an address indicative of a place at which one or a plurality of successive memory cells exist where data equivalent to the size of said memory requested to be ensured can be successively stored, with a memory cell at said state of “not in use” or “partly in use” as a leading address,
a memory ensuring step of ensuring said memory region equivalent to the minimum number of successive memory cells necessary for satisfying the size of said memory requested to be ensured by using an address searched by the address searching step, and
a bit map unit changing step of changing states of a bit map corresponding to a memory cell ensured by the memory ensuring step and a bit map corresponding to a memory cell whose layer is higher than the layer of the ensured memory cell and whose state is subjected to a change into “partly in use” or “in use” according to the state obtained after the change.

36. A memory management method comprising:
a memory region size storing step of storing a size of a predetermined-size readable and writable memory region,
a first memory size storing step of storing a size of a fixed-length block as a first memory cell which divides a memory region of a size stored in the memory region size storing step,
a first bit map unit storing step of storing a state of use of each said first memory cell in said memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
a second to a-th bit map unit storing step of, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
a memory cell layer selecting step of, upon a request for ensuring memory in said memory region, selecting a layer of a memory cell whose size is smaller than and most approximate to the requested memory size,
an address searching step of searching a bit map unit corresponding to a memory cell of a layer selected by the memory cell layer selecting step for an address indicative of a place at which one or a plurality of successive memory cells exist where data equivalent to the size of said memory requested to be ensured can be successively stored, with a memory cell at said state of “not in use” or “partly in use” as a leading address,
a memory ensuring step of ensuring said memory region equivalent to the minimum number of successive memory cells necessary for satisfying the size of said memory requested to be ensured by using an address searched by the address searching step, and
a bit map unit changing step of changing a bit map corresponding to a memory cell ensured by the memory ensuring step into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

37. A memory management method comprising:
a memory region size storing step of storing a size of a predetermined-size readable and writable memory region,
a first memory size storing step of storing a size of a fixed-length block as a first memory cell which divides a memory region of a size stored at the memory region size storing step,
a first bit map unit storing step of storing a state of use of each said first memory cell in said memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
a second to a-th bit map unit storing step of, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
a one-order higher layer memory cell selecting step of, upon a request for ensuring memory in said memory region, determining whether there exists a memory cell whose size is relatively close to and larger than the requested memory size,
a first memory cell layer selecting step of, when the one-order higher layer memory cell selecting step determines that there exists no memory cell satisfying the condition, selecting a layer of a memory cell whose size is smaller and most approximate to the requested memory size,
a second memory cell layer selecting step of, when said one-order higher layer memory cell selecting step determines that there exists a memory cell satisfying the condition, selecting the memory cell of the layer,
an address searching step of searching a bit map unit corresponding to a memory cell of a layer selected by said first or second memory cell layer selecting step for an address indicative of a place at which one or a plurality of successive memory cells exist where data equivalent to the size of said memory requested to be ensured can be successively stored, with a memory cell at said state of “not in use” or “partly in use” as a leading address,
a memory ensuring step of ensuring said memory region equivalent to the minimum number of successive memory cells necessary for satisfying the size of said memory requested to be ensured by using an address searched by the address searching step, and
a bit map unit changing step of changing a bit map corresponding to a memory cell ensured by the memory ensuring step into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

38. A memory management method comprising:
a memory region size storing step of storing a size of a predetermined-size readable and writable memory region,
a first memory size storing step of storing a size of a fixed-length block as a first memory cell which divides a memory region of a size stored at the memory region size storing step,
a first bit map unit storing step of storing a state of use of each said first memory cell in said memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
a second to a-th bit map unit storing step of storing, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, storing a state of use of each memory cell as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
a memory cell selecting step of, upon a request for ensuring memory in said memory region, selecting a combination of memory cells satisfying said requested memory size by combining a memory cell whose size is smaller than and most approximate to the requested memory size and a memory cell of a further smaller size,
an address searching step of searching a bit map unit corresponding to a memory cell of each layer selected by the memory cell selecting step for an address indicative of a place at which one or a plurality of successive memory cells exist where data equivalent to the size of said memory requested to be ensured can be successively stored, with a memory cell at said state of “not in use” or “partly in use” as a leading address,
a memory ensuring step of ensuring said memory region equivalent to the minimum number of successive memory cells necessary for satisfying the size of said memory requested to be ensured by using an address searched at the address searching step, and
a bit map unit changing step of changing a bit map corresponding to a memory cell ensured by the memory ensuring step into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.

39. A memory management method comprising:
a memory region size storing step of storing a size of a predetermined-size readable and writable memory region,
a first memory size storing step of storing a size of a fixed-length block as a first memory cell which divides a first memory region obtained by dividing a memory region of a size stored at the memory region size storing step in half at a predetermined address as a boundary,
a first bit map unit storing step of storing a state of use of each said first memory cell in said first memory region as a bit map indicative any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored,
a second to a-th bit map unit storing step of, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, allocating these memory cells to said first memory region and a remaining second memory region and storing a state of use of each memory cell corresponding to the first and the second memory regions as a bit map,
a memory cell layer selecting step of, upon a request for ensuring memory in said memory region, selecting a layer of a memory cell whose size is smaller than and most approximate to the requested memory size,
an address searching step of searching a bit map unit corresponding to a memory cell of a layer selected by the memory cell layer selecting step for an address indicative of a place at which the minimum number of successive memory cells exist necessary for satisfying the size of said memory requested to be ensured, and
a memory ensuring step of ensuring said memory region equivalent to the minimum number of successive memory cells necessary for satisfying the size of said memory requested to be ensured by using an address searched by the address searching step.

40. A memory management method comprising:
a memory region size storing step of storing a size of a predetermined-size readable and writable memory region,
a first memory size storing step of storing a size of a fixed-length block as a first memory cell which divides a first memory region obtained by dividing a memory region of a size stored at the memory region size storing step in half at a predetermined address as a boundary,
a first bit map unit storing step of storing a state of use of each said first memory cell in said first memory region as a bit map,
a second to a-th bit map unit storing step of, when each N times, which is a predetermined integral multiple, the memory amount of said first memory cell is grouped into a higher-order memory cell and each N times the memory amount of the higher-order memory cell is further grouped into a further higher-order memory cell to layer said memory region to have (a−1) layers (a: integer not less than 2) as the maximum layer and set these memory cells as the second to a-th memory cells, representing a state of use of each memory cell as any of four states of “not in use” indicating a state where a memory cell is not in use, “partly in use” indicating a state where a memory cell is partly in use, “in use” indicating a state where all the memory cell is in use, and “head of allocation” indicating the head of a memory cell where data of a requested memory size is stored, allocating these memory cells to said first memory region and a remaining second memory region and storing a state of use of each memory cell corresponding to the first and the second memory regions as a bit map,
a memory cell selecting step of, upon a request for ensuring memory in said memory region, selecting a combination of memory cells satisfying said requested memory size by combining a memory cell whose size is smaller than and most approximate to the requested memory size and a memory cell of a further smaller size,
an address searching step of searching a bit map unit corresponding to a memory cell of each layer selected by the memory cell selecting step for an address indicative of a place at which one or a plurality of successive memory cells exist where data equivalent to the size of said memory requested to be ensured can be successively stored, with a memory cell at said state of “not in use” or “partly in use” as a leading address,
a memory ensuring step of ensuring said memory region equivalent to the minimum number of successive memory cells necessary for satisfying the size of said memory requested to be ensured by using an address searched at the address searching step, and
a bit map unit changing step of changing a bit map corresponding to a memory cell ensured at the memory ensuring step into “partly in use”, “in use” or “head of allocation”, as well as changing a state of a bit map corresponding to a memory cell whose layer is higher than the layer of the ensured memory cell and whose state is subjected to a change into “partly in use” or “in use” according to the state obtained after the change.
